(19) United States
(12) Patent Application Publication
(10) Pub. No.: US 2025/0322476 A1
(43) Pub. Date: Oct. 16, 2025

(54) MULTI-AGENT WORKSHOP DESIGNER

(71) Applicant: 2hr Learning, Inc., Austin, TX (US)

(72) Inventors: Andrei Kharytonenka, Austin, TX (US); Saksham Mittal, Haryana (IN)

(73) Assignee: 2hr Learning, Inc., Austin, TX (US)

(21) Appl. No.: 19/177,491

(22) Filed: Apr. 11, 2025

Related U.S. Application Data
(60) Provisional application No. 63/633,013, filed on Apr. 11, 2024.

(51) Int. Cl. G06Q 50/20; G06Q 10/10

(52) U.S. Cl. CPC G06Q 50/205; G06Q 10/10

(57) ABSTRACT

A workshop planner client computer system communicates with an artificial intelligence (AI) workshop generation system for the generation of workshops based on inputs provided by a user. The AI-based workshop generation system is configured to receive natural language workshop generation request data from the workshop planner client computer system. The workshop generation request includes a natural language request data describing the life skill and level of education for which the workshop is desired. The received natural language request data is then processed by the AI-based workshop generation system using an artificial intelligence system. During the workshop generation process, the AI-based workshop generation system also accesses a curriculum database including curriculum data for one or more educational standards. The curriculum database helps the AI-based workshop generation system to align the generated workshop and test2pass with the educational standards.

### CROSS-REFERENCE TO RELATED APPLICATION

This application claims the benefit under 35 U.S.C. § 119(c) and 37 C.F.R. § 1.78 of U.S. Provisional Application No. 63/633,013, filed Apr. 11, 2024, which is incorporated by reference in its entirety.

### FIELD OF THE INVENTION

The present invention relates in general to the field of electronics, and more specifically to an artificial intelligence based workshop generation system (AI-based workshop generation system) automating the creation of workshops in real-time based on user inputs.

### BACKGROUND OF THE INVENTION

In the dynamic landscape of modern education, workshops play a crucial role as channels for interactive learning, stimulating increased engagement, collaboration, and the development of critical thinking skills among participants. Workshops are practical training sessions where participants can learn new skills and gain hands-on experience in a particular topic or field. Most of the workshops are designed to be interactive and engaging, focusing on active learning. Workshops go beyond conventional lecture styles and are tailored to accommodate various participants' requirements. Unlike lectures, where information flows predominantly in one direction, workshops invite participants to engage with the subject matter directly, often through group activities, problem-solving tasks, or skill-building exercises.

The conventional process of designing workshops is time-consuming and labor-intensive, necessitating extensive collaboration among educators, curriculum developers, and subject matter experts. This manual approach involves intricate planning, meticulous resource gathering, and the careful alignment of instructional strategies with learning objectives. However, despite the efforts invested in designing the workshops, there are inconsistencies in the quality of workshop design. Moreover, personalization of workshops to cater to diverse participant needs and preferences is difficult as each participant may have unique learning styles, abilities, and interests. Furthermore, scaling the design process of the workshops to accommodate varying class sizes, educational contexts, and learning objectives presents another hurdle. The educators struggle to adapt to effectively meet the evolving needs of different participants or to replicate successful workshop models for diverse group of participants.

### SUMMARY

One or more embodiments of a method include:
providing a user interface to integrate communication between a workshop planner client computer system and an artificial intelligence based workshop generation system (AI-based workshop generation system) to:
   receive a workshop generation request from a user via the user interface of the workshop planner client computer system;
   transmit the workshop generation request to the AI-based workshop generation system, wherein the AI-based workshop generation system includes an artificial intelligence system having a natural language processing engine that includes a language model and machine learning algorithms;
receiving, with the AI-based workshop generation system, the workshop generation request from the workshop planner client computer system, wherein the workshop generation request includes a natural language request data describing a life skill and a level of education for which the workshop is desired; and
processing the workshop generation request data by the AI-based workshop generation system comprises:
   accessing a curriculum database including curriculum data for one or more life skills, wherein the curriculum data includes a plurality of life skill topics and corresponding topic details;
   matching the received workshop generation request data to the curriculum data to identify a matching topic in the curriculum data;
   identifying an objective of a workshop by using a research module, wherein the research module includes a plurality of research agents, and wherein each research agent from the plurality of research agents comprises a research prompt to develop methodologies for creating workshop content related to the selected topic corresponding to the workshop generation request;
   creating a test2pass for the workshop by using a test2pass module, wherein the test2pass module includes a plurality of test2pass agents, and wherein each test2pass agent from the plurality of test2pass agents comprises a test2pass prompt to create test2pass; and
   generating a workshop by using a workshop module, wherein the workshop module includes a plurality of workshop agent, and wherein each workshop agent from the plurality of workshop agents comprises a workshop prompt to generate and align the workshop with the workshop generation request data; and
providing data to display the workshop and the test2pass simultaneously to a user via the user interface of the workshop planner client computer system.

One or more embodiments of a system include:
a user interface provided to integrate communication between a workshop planner client computer system and an artificial intelligence (AI)-based workshop generation system (AI-based workshop generation system), wherein the user interface is capable to
   receive a workshop generation request from a user via the user interface of the workshop planner client computer system;
   transmit the workshop generation request to the AI-based workshop generation system, wherein the AI-based workshop generation system includes an artificial intelligence system having a natural language processing engine that includes a language model and machine learning algorithms;
wherein the AI-based workshop generation system receives and processes the workshop generation request from the workshop planner client computer system, wherein the workshop generation request includes a natural language request data describing the life skill and level of education for which the workshop is desired, the AI-based workshop generation system comprises:
   a curriculum database including curriculum data for accessing one or more educational standards, wherein the curriculum data includes a plurality of life skill topics and topic details to match the received workshop generation request data to the curriculum data to identify a matching topic in the curriculum data;
   a research module for identifying an objective of a workshop, wherein the research module includes a plurality of research agents, and wherein each research agents from the plurality of research agents comprises a research prompt to develop methodologies for creating workshop content related to the selected topic corresponding to the workshop generation request;
   a test2pass module for creating a test2pass, wherein the test2pass module includes a plurality of test2pass agents, and wherein each test2pass agent from the plurality of test2pass agents comprises a test2pass prompt to create test2pass;
   a workshop module for generating a workshop, wherein the workshop includes a plurality of workshop agent, and wherein each workshop agent from the plurality of workshop agent comprises a workshop prompt to generate and align the workshop with the workshop generation request data; and
   data to display to a user via the user interface of the workshop planner client computer system the workshop and the test2pass simultaneously.

### BRIEF DESCRIPTION OF THE DRAWINGS

The systems and methods described herein may be better understood, and their numerous objects, features, and advantages made apparent to those skilled in the art by referencing exemplary embodiments depicted in the accompanying figures. The use of the same reference number throughout the several figures designates a like or similar element.

FIG. 1 depicts an exemplary workshop planner client computer system and AI-based workshop generation system in an environment.

FIG. 2 depicts an exemplary workshop generation process using the workshop planner client computer system and AI-based workshop generation system of FIG. 1.

FIG. 3 depicts a flow diagram of the processing a workshop generation request within the AI-based workshop generation system.

FIGS. 4-20 depict exemplary user interface displays for allowing interaction between the user and the workshop planner client computer system.

FIG. 21 depicts an exemplary network environment in which the system of FIG. 1 and the process of FIG. 2 may be practiced.

FIG. 22 depicts an exemplary computer system.

### DETAILED DESCRIPTION

A workshop planner client computer system communicates with an artificial intelligence (AI) workshop generation system (AI-based workshop generation system) for the generation of workshops based on inputs provided by a user. The AI-based workshop generation system is configured to receive natural language workshop generation request data from the workshop planner client computer system. The workshop generation request includes a natural language request data describing the life skill and level of education for which the workshop is desired. The received natural language request data is then processed by the AI-based workshop generation system using an artificial intelligence system having a natural language processing engine that includes a language model and machine learning algorithms. During the workshop generation process, the AI-based workshop generation system also accesses a curriculum database including curriculum data for one or more educational standards. The curriculum database helps the AI-based workshop generation system to align the generated workshop and test2pass with the educational standards.

The AI-based workshop generation system leverages the artificial intelligence system having a natural language processing engine that includes a language model and machine learning algorithms to automate the creation of workshops tailored based on the user inputs. The use of AI-based workshop generation system to generate workshop and validate test2pass by aligning with the curriculum data and the grade level of the learner simplifies the workshop creation process, thereby reducing the time and effort required by the user for generation of the workshop and ensures the quality. The AI-based workshop system is capable of generating a variety of Test2Pass that are not only tailored to the learner's learning journey but also designed to be engaging and reflective of real-world scenarios. This represents a significant advancement over traditional, one-size-fits-all assessments.

The AI-based workshop generation system utilizes multi agents for creation of the workshop and test2pass. The multi-agents utilized within the AI-based workshop generation system a paradigm shift by introducing a collaborative AI approach where multi agents work together to streamline the workshop creation process. This not only increases efficiency but also ensures that each aspect of the workshop, from content to test2pass, is optimized for learners. The test2pass represents an assessment generated using AI to create dynamic, performance-based challenges that are tailored to the learner's learning journey and real-world applicability. The AI-based workshop generation system can generate a variety of test2pass that not only assess but also help to develop life skills of the learner. The AI-based workshop generation system is designed as a pipeline of processes, each focusing on a specific task, running on a distributed system in the cloud. This design allows for efficient handling of tasks, scalability, and robustness, ensuring that the AI-based workshop generation system can serve many users simultaneously while maintaining high performance.

The system and method set forth herein address technical issues with generating the desired outputs described herein. Conventionally, manual processes were used to generate the desired outputs and were very tedious and time consuming. The present system and method utilize an automated system that does not merely automate a manual process or use a conventional system in a conventional way. The present system and method utilize one or more artificial intelligence (AI) engines and integrate programmatic process management to technologically guide and constrain the one or more AI engines to produce the desired outputs in a completely different way than both any manual process and different than normal use of programs and AI engines. Utilizing specially engineered guidance and control to direct an AI system to solve the problems below presents a technical problem that requires a technical solution. The system and method described below are not simply engaging a computer to carry out conventional mental processes, but rather change how computers (and AI systems, specifically) operate to achieve the generation results that were not previously possible or were substantially inefficient prior to the system and method set forth below. The AI system needs specific technical guidance, control, and constraints to achieve results that are not otherwise achievable.

Prompts are used to guide and constrain each AI engine. The prompts guide each AI engine by steering the AI engine(s). “Guiding” an AI engine refers to providing the AI engine with a general direction or framework to shape the AI engine's behavior or decision-making process. Guiding sets goals or principles. Guiding allows the AI engine some flexibility to interpret and adapt, much like giving it a compass to navigate rather than a fixed path.

Constraining each AI engine includes imposing specific, hard limits or rules on what each AI engine can do. Constraining an AI engine can also include providing specific input data to not only guide but also constrain the scope of each AI engine's reasoning basis and response. Constraining each AI engine assists with aligning the AI engine(s) for its (their) intended use.

Normally AI engines are provided a single user prompt requesting the AI engine, such as OpenAI's ChatGPT and its various implementations such as Anthropic's Claude Sonnet, to perform a task and produce an output. However, this conventional AI engine prompting method has a variety of technical shortcomings. Without proper guidance and constraints, an AI engine will not produce the desired output specified as produced by the system and method described herein. Instead, the AI engine will produce many unusable outputs that are unusable for a variety of reasons including so-called “hallucinations” where the AI engine presents fabricated information, duplicate outputs, too few outputs, too many outputs, outputs that do not meet desired criteria, and so on. Without special technical guidance, the AI engine cannot reliably be applied to generate desired outcomes.

The system and method generate decomposed, technically engineered AI prompts to include selected and integral AI engine guidance and constraints. The technically engineered prompts are generated and guided with programmatic, automatic inputs specifically designed to unconventionally guide and constrain an AI engine to produce desired outputs, perform quality control to retain or automatically discard outputs that do not meet guidance and constraints, and make the desired outputs available for use, such as use by computer system applications. In at least one embodiment, the problem to be solved by the integrated programmatic and AI engine system and method is uniquely and unconventionally decomposed, and AI prompts are used to solve the decomposed problem. Furthermore, the programmatic inputs to the decomposed AI prompts provide guidance to meet desired output characteristics.

Determining a number of prompts, the guidance and constraints within each prompt, and data flowing from one AI engine prompt to another, in addition to testing a number of prompts for the decomposed problem, testing within each prompt, and validating a desired quality of outputs becomes an intractable combinatorial problem without technical guidance and constraint of the system and method described herein. Thus, the present system and method described implement an integration of programmatic management over decomposed prompts with engineered AI engine guidance and constraints to effect an improvement in AI, programmatic AI management, and AI integrated with programmatic management technology. The present system and method allow computer systems to include programmatic management, one or more AI engines, and one or more data sources to produce the output described herein that previously could not be produced with conventionally prompted AI engines or could only be produced by humans utilizing a completely different, time consuming, and tedious process. The system and method improve conventional methods through the use of a programmatic AI engine management system to generate decomposed, technically engineered AI prompts to include selected and integral AI engine guidance and constraints. It is, for example, the incorporation of the programmatic AI engine management system to generate decomposed, technically engineered AI prompts to include generated, integral, and unconventional AI engine guidance and constraints and execution by the one or more AI engines to provide useful results that improve existing technical processes, which is not an automation of a conventional process.

Programmatic components and AI engines generally utilize one or more processors that have access to memory, which may include one or more storage components, to execute and perform functions. An AI engine is a core hardware and software system that enables artificial intelligence applications to process data, learn patterns, and generate insights or actions. It functions as the brain behind AI-driven systems, facilitating tasks such as machine learning, natural language processing, and decision-making. Exemplary components of an AI engine are:
1. Machine Learning Models—Algorithms that analyze data, recognize patterns, and make predictions.
2. Neural Networks—Deep learning architectures that mimic the human brain for tasks like image and speech recognition.
3. Data Processing Module—Handles raw data input, transformation, and feature extraction.
4. Inference Engine—Applies trained models to make real-time decisions based on new data.
5. Optimization Algorithms—Improves model efficiency, reducing errors and improving predictions.
6. Natural Language Processing (NLP) Module—Enables AI engines to understand, interpret, and generate human language (e.g., chatbots, voice assistants).
7. Computer Vision Module—Allows AI to interpret and analyze images or videos.
8. Reinforcement Learning Mechanism—Helps AI learn from trial and error, optimizing performance over time.
9. API Interface—Connects the AI engine with applications, enabling integration with other software or platforms.

Examples of AI Engines include: XAI's Grok and variations thereof, Google TensorFlow, Meta's PyTorch, Microsoft Azure AI, OpenAI's ChatGPT and variations thereof, IBM Watson, OpenAI Whisper, Google BERT & T5, Amazon Lex, Anthropic Claude, DeepMind's AlphaCode, Google Vision AI, Meta's DINO & SAM (Segment Anything Model), NVIDIA DeepStream. OpenCV AI Kit, Amazon Polly. Google WaveNet, Deepgram.

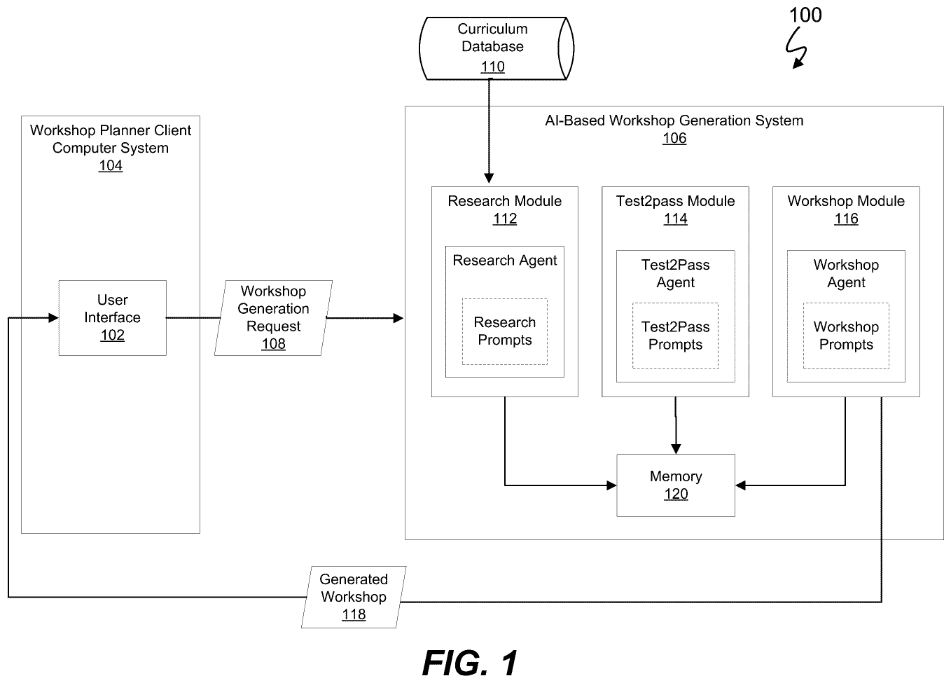

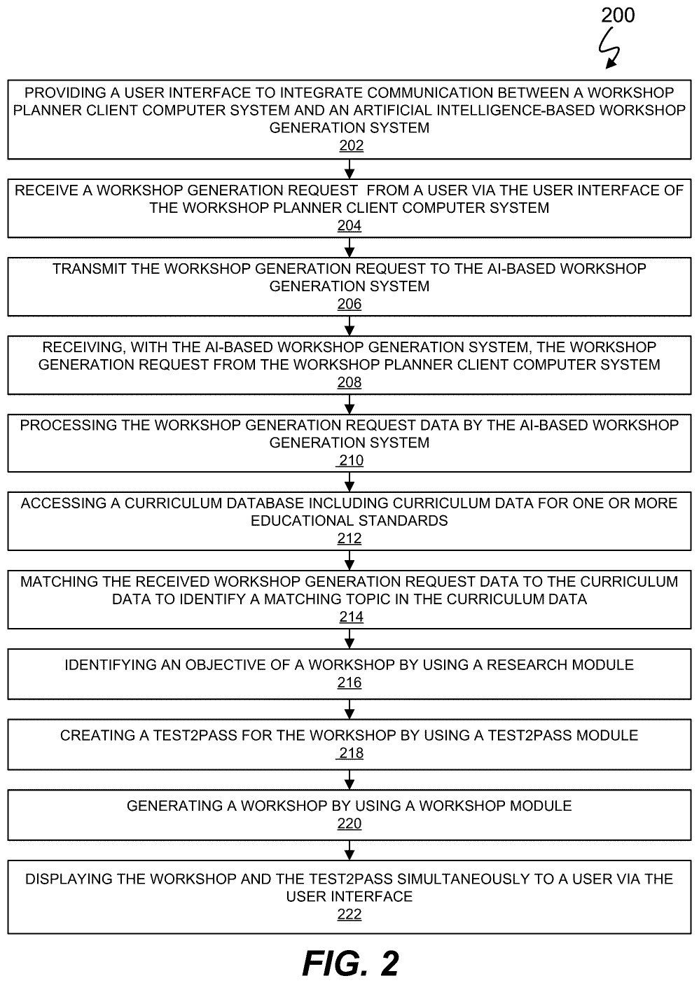

FIG. 1 depicts an exemplary AI-based workshop generation environment 100 to generate workshops by a user using a workshop planner client computer system 104. FIG. 2 depicts an exemplary workshop generation process 200 utilized by the AI-based workshop generation environment 100.

Referring to FIGS. 1 and 2, in operation 202 a user interface 102 is provided to a user for generating a workshop via a workshop planner client computer system 104. The user interface 102 integrates communication between the workshop planner client computer system 104 and an artificial intelligence (AI) workshop generation system (AI-based workshop generation system) 106. The workshop planner client computer system 104 serves as a digital environment provided to the user to generate and share the workshop with a learner (or group of learners). The generated workshops are used as a tool to assess learning experience of the learner. The learner is a person who is receiving the workshop and the user can be teacher, tutor, instructor, or coach who is delivering the workshop to the learner. In one embodiment, the workshop is a collaborative space where learners with shared interests or goals come together to engage in hands-on activities, discussions, and learning experiences. The workshop typically involves a specific focus, such as skill development. The workshops generated by the user can vary widely in format and duration, ranging from short sessions to multi-day events. Moreover, the workshop helps in improving the learning ability of the learner along with improving teaching styles adopted by the user. The workshop planner client computer system 104 provides a flexible platform to the user, allowing generation of workshops and providing the guidelines to use the workshops to the learner.

The AI-based workshop generation system 106 is a back-end system that leverages artificial intelligence (AI) to automate the creation of the workshops in real time. The AI-based workshop generation system 106 enhances the efficiency, accessibility, and effectiveness of workshops by transitioning workshops to digital environments, by allowing the user to generate workshops remotely at their convenience. The AI-based workshop generation system 106 ensures smooth data exchange, streamlined workflows, and enhanced user experience. Typically, the AI-based workshop generation system 106 offers comprehensive guidance on how the workshop should be conducted by the user, providing detailed insights into the sequence of activities, recommended methodologies, and practices to ensure a smooth and productive session. The AI-based workshop generation system 106 furnishes a framework encompassing pre-workshop preparations, including engagement strategies and logistical arrangements, as well as in-workshop facilitation techniques for effective communication, collaboration, and knowledge dissemination. The AI-based workshop generation system 106 automates the design of personalized life skill workshops and assessments, enabling a more efficient and targeted approach to skill development. By utilizing advanced algorithms and natural language processing, the AI-based workshop generation system 106 can quickly generate customized content that aligns with each learner's unique learning needs and progress. This not only reduces the workload for the user but also ensures a consistent and high-quality learning experience for the learners. In at least one embodiment, the workshop planner client computer system 104 is able to adapt and scale to make it an invaluable tool for schools looking to enhance their life skill curriculum and better prepare students for the challenges of the future.

The user logs into the workshop planner client computer system 104 through a user device. The user device includes a computer, desktop, mobile device or any other device that is capable of using the internet and can access the workshop planner client computer system 104. Upon authentication, the user can log in to the workshop planner client computer system 104. Typically, the authentication requires the user to provide login credentials, for example, username and password, via the user interface 102 of the workshop planner client computer system 104. Upon authentication, the workshop planner client computer system 104 establishes a connection with the AI-based workshop generation system 106. The user interface 102 serves as a gateway for the user to initiate workshop creation processes. The user interface 102 is designed in a way to allow the user to easily prepare the workshops and deliver the workshop to the learner. In addition, the user interface 102 also ensures that the user can navigate the workshop planner client computer system 104 with case.

In operation 204, the user provides workshop generation request 108 via the user interface 102 of the workshop planner client computer system 104. The workshop generation request 108 is the process of initiating the creation of the workshop. The workshop generation request 108 includes specific criteria or learning objectives that the workshop should cover, as well as any preferred formats or methodologies. In one embodiment, the workshop generation request 108 includes a natural language request data including describing the life skill and level of education for which the workshop is desired. The selected life skill by the user allows the AI-based workshop generation system 106 to create the workshop related to specific selected life skills to be included therein. The user further selects the level of education to be included in the workshop, where the level of education include life skill description corresponding to the life skill, sub-skill associated with the life skill, sub-skill description corresponding to the sub-skill. The user provides input related to the complexity of the workshop by selecting a grade level (or grade) of the learner (or group of learners) so that the workshop aligns to the competence level of the learner as per the grade he/she is in.

Once the workshop generation request 108 is made, the AI-based workshop generation system 106 is responsible for developing the workshop that aligns with the goals of the learner. The workshop generation request 108 provides a means of gauging the understanding or proficiency of the learner in a particular life skill corresponding to the workshop, enabling decision-making regarding the progress of the learner.

In operation 206, the AI-based workshop generation system 106 receives the workshop generation request 108. The AI-based workshop generation system 106 includes an artificial intelligence system having a natural language processing engine that includes a language model and machine learning algorithms. The AI-based workshop generation system 106 uses the artificial intelligence (AI) system to receive and process workshop generation requests. The AI system includes language models and machine learning algorithms. The AI system understands and interprets the submitted workshop generation request 108 using the natural language processing engine. Moreover, the machine learning algorithms enable the AI system to improve its performance. For example, if the workshop generation request 108 includes “critical thinking” as the life skill for generation of a workshop, the AI system generates the workshop that accurately assesses the learner's comprehension of that life skill.

In operation 208, the AI-based workshop generation system 106 receives the workshop generation request 108 from the workshop planner client computer system 104. The workshop generation request 108 includes a natural language request data describing the life skill and level of education for which the workshop is desired. The natural language request data serves as a parameter that defines the scope of the workshop to be generated, thereby enabling generation of personalized and adaptive workshop matching to the unique needs and preferences of the learner. The “life skill” determines the flow of the workshop and learning to be received within the workshop. The life skills are the essential abilities that enable the learner to effectively navigate various aspects of daily life, fostering personal growth, well-being, and success. The life skills encompass a broad range of competencies, including communication, problem-solving, decision-making, critical thinking, time management, resilience, and interpersonal relationships. Typically, life skills are not only crucial for managing practical tasks and responsibilities but also for navigating social interactions, coping with challenges, and pursuing personal goals.

The natural language request data also includes the level of education. The level of education include the life skill description, sub-skill, sub-skill description. Typically, life skill description refers to the categorization of a specific life skill, such as communication or problem-solving by describing the exact purpose of the life skill. The “sub-skill” is a categorization of the life skill. The sub-skill represents a specific area or proficiency within the larger life skill set, contributing to its overall effectiveness and application. For instance, within the life skill of communication, a sub-skill could be active listening. Active listening involves not only hearing the words spoken by others but also understanding their meaning, empathizing with their perspective, and providing appropriate responses. Also, the life skill description provides a general overview of the sub-skill. According to UNICEF, UNESCO and WHO list the core life skills are as follows: problem solving, critical thinking, effective communication skills, decision-making, creative thinking, interpersonal relationship skills, self-awareness building skills, empathy, and coping with stress and emotions. Moreover, the sub-skills are the subtopics within each life skill.

By incorporating the natural language request data, the AI-based workshop generation system 106 can deliver workshops that are aligned with the specific life skills to the learner. The natural language request data enables targeted workshops that address specific learning objectives, competencies, or instructional priorities. The AI-based workshop generation system 106 offers diverse and engaging workshop experiences that cater to different learning styles, cognitive processes, and objectives of the learner. The AI-based workshop generation system 106 encompasses various factors such as the depth of subject matter, the language and vocabulary used in the workshop. The AI-based workshop generation system 106 offers details of the workshop, day plan of the workshop, conversation, comment and feedback for re-generation of the workshop. The AI-based workshop generation system 106 outlines a structured day plan delineating the various sessions, breaks, and activities scheduled throughout the workshop duration. Additionally, AI-based workshop generation system 106 also facilitates seamless communication among learners, enabling discussions, sharing of insights, and collaborative problem-solving during the presentation of the workshop. Moreover, the AI-based workshop generation system 106 collects feedback from different users, including comments and suggestions, to iteratively refine and enhance the workshop content, format, and delivery for future iterations. This feedback loop ensures continuous improvement and adaptation to meet the evolving needs and expectations of the learners.

In operation 210, the AI-based workshop generation system 106 processes the received workshop generation request 108 and natural language request data. When the AI-based workshop generation system 106 receives the workshop generation request 108 and natural language request data from the user, the AI-based workshop generation system 106 analyzes the natural language input by using AI algorithms, the AI-based workshop generation system 106 parses the request to understand its meaning, identifying key components such as the life skill and level of education indicated by the user. Then, the AI-based workshop generation system 106 selects relevant life skills, adjusting difficulty levels if necessary, and coherently organizing the content. Moreover, the AI-based workshop generation system 106 may also employ machine learning techniques to improve understanding of the user's request, thereby enhancing its ability to generate high-quality workshops.

In operation 212, the AI-based workshop generation system 106 accesses a curriculum database 110 including curriculum data for one or more educational standards. The AI-based workshop generation system 106 relies on the curriculum database 110 containing structured information about one or more educational standards. The one or more educational standards are the board of education, school committee or school board that determines the educational policy in a city, county, state, or province. Typically, the curriculum database 110 includes the plurality of life skill topics and detailed content of individual topics. The curriculum database 110 is a detailed listing of the life skill topics that the learners are expected to learn at different grade levels. The AI-based workshop generation system 106 is configured to align the generated workshop based on the curriculum database 110. For example, the life skill topic selected by the user is critical thinking, the curriculum database 110 categorizes critical thinking into various topics such as sub-skills that are aligned with the education standards. Under each of these life skill topics, there would be subtopics such as sub-skills and a detailed breakdown of concepts and skills that the learner should acquire at each grade level. This plurality of life skill topics and detailed content of individual topics enables the AI-based workshop generation system 106 to create workshops that align with the grade level of the learner, ensuring that the workshop is relevant, appropriate in difficulty, and cover the necessary content areas. By leveraging the curriculum data, the AI-based workshop generation system 106 can efficiently generate workshops that accurately reflect the educational standards and learning objectives that support effective teaching and learning processes. In at least one embodiment, the curriculum database 110 incorporates a comprehensive set of tools and utilities for managing and updating educational standards and educational standards requirements, ensuring that the workshop generated remains aligned with the latest guidelines and regulations. The curriculum data within the curriculum database 110 automatically retrieves and synchronizes updates to educational standards, enabling timely adjustments to the workshop as needed. The access to the curriculum database 110 is provided through the API endpoints of the curriculum database 110. The API endpoints allow the AI-based workshop generation system 106 to communicate with and retrieve information from the curriculum database 110.

Typically, matching the received workshop generation request data with the curriculum data to identify a matching topic in the curriculum data involves using natural language processing techniques to analyze the life skill details provided in the workshop generation request data and extracting key steps that are relevant to the topic. Then, these extracted key steps are compared to the numerous topics and detailed content stored in the curriculum data. Next, the AI-based workshop generation system 106 identifies one or more topics from the curriculum data that closely align with the topic details from the request data. The workshop enables the learner to acquire new knowledge, skills, and perspectives through hands-on activities and discussions.

In operation 214, the AI-based workshop generation system 106 matches the received workshop generation request data to the curriculum data. Typically, matching the request data to the curriculum data identifies the selected life skill by the user is related to the topic that is relevant to the learner corresponding to the educational standards. The AI-based workshop generation system 106 compares the workshop generation request data to the information stored within the curriculum database 110. The AI-based workshop generation system 106 aims to identify the relevant topics and corresponding content from the curriculum data that aligns with the workshop generation request 108. The AI-based workshop generation system 106 analyzes the workshop generation request data by extracting key parameters such as a life skill and level of education to be included in the requested workshop. Then the AI-based workshop generation system 106 refers to the curriculum database 110, which contains detailed information about the life skill topics and content covered in the educational standards for the requested life skill. The curriculum data is aligned to one or more educational standards including Common Core State Standards (CCSS), Next Generation Science Standards (NGSS), College Board, and so on which houses comprehensive details of each topic included in these curriculum. The AI-based workshop generation system 106 matches the parameters of the workshop generation request data to the corresponding entries in the curriculum database 110. This matching process involves identifying the life skills relevant to the workshop and retrieving the associated content outlined within the curriculum data. For example, if the workshop request pertains to critical thinking for eighth-grade students, the AI-based workshop generation system 106 locates the critical thinking topic within the curriculum database 110 for eighth grade and extract specific guidelines and corresponding study material to be included in the workshop plan that the learners are expected to learn at that level, to align the workshop with the educational standards. The AI-based workshop generation system 106 is configured to align the workshop generation request 108 with the curriculum data, the AI-based workshop generation system 106 ensures that the generated workshop reflects the educational standards and learning objectives appropriate for the intended grade level and life skill. In this regard, the AI-based workshop generation system 106 ensures that the workshop is tailored to the educational needs of the learner and covers the essential topic.

In operation 216, the AI-based workshop generation system 106 employs a research module 112 to identify the objective of the workshop. The research module 112 includes a plurality of research agents, and each research agent includes a research prompt to develop methodologies for creating workshop content related to the selected topic corresponding to the workshop generation request. The AI-based workshop generation system 106 firstly examines the provided workshop generation request data, including details such as skill and level of education. The workshop generation request 108 also includes data such as the grade level and difficulty level of the target audience. By systematically analyzing the workshop generation request, the AI-based workshop generation system 106 gains a comprehensive understanding of the goals and outcome from the workshop. Then, the plurality of research agents are employed. The plurality of research agents include the plurality of research prompts applied to the workshop generation request data to uncover additional insights and perspectives. The plurality of research prompts include research global assessments prompt, research assessment tools prompt, final assessment ideas summarization prompt, and research assessment questions generation prompt. By utilizing a diverse range of the plurality of research prompts, the AI-based workshop generation system 106 gathers the workshop content that informs the development of effective workshop methodologies. The workshop content is data associated with the workshop highlights the themes, and priorities related to the selected life skill of the workshop. This process involves distilling complex information into actionable insights that inform the design of workshop content. By identifying the workshop content, the AI-based workshop generation system 106 can tailor the workshop objectives to address the specific needs and preferences of the learner. Additionally, with a clear understanding of the workshop objectives, the AI-based workshop generation system 106 can begin to develop methodologies for creating workshop content that aligns with the educational standards.

For example, one of the research agent from the plurality of research agents is “Research Global Assessments Prompt”. The Research Global Assessments Prompt provides assessments relevant to a life skill. To that end, the data available to the AI-based workshop generation system 106 is life_skill, sub_skill, life_skill_description, sub_skill_description, grade_level, standards, example_test2passes. The corresponding research prompt provided to the Research Global Assessments Prompt is:

Provide me with a comprehensive list of well-known global assessments that
are used to evaluate life skill: “{life_skill}”, and specifically, the sub-
skill: “{sub_skill}” with a brief description of each assessment, focusing on
its relevance to the specified skills, the methodology it employs, and its
geographical reach. Additionally, include any relevant links to where I can
find more detailed information or access the assessment tools.”

Another example, a research agent from the plurality of research agents is “Research Assessment Tools Prompt”. The Research Assessment Tools Prompt provides relevant tools and platforms that can be used to assess students on a given life skill. The corresponding research prompt provided to the Research Assessment Tools Prompt is:

Identify and recommend assessment tools, websites, and platforms for
assessing students for life skill: “{life_skill}”, focusing on a
sub-skill: “{sub_skill}”. Please ensure that each recommendation is
accompanied by references or links to the sources.

Yet another example of a research agent is “Final Assessment Ideas Summarization Prompt”. The Final Assessment Ideas Summarization Prompt summarizes the final assessment ideas that align with ideal assessment attributes. The corresponding research prompt provided to the Final Assessment Ideas Summarization Prompt is:

```
You are an expert educator specializing in creation of assessments in life
skills. Your goal is to design challenging assessments that push students
beyond traditional limits and age expectations.
Given:
Life Skill: {sub_skill}
Life Skill Description: {sub_skill_description}
Parent Life Skill: {life_skill}
Parent Life Skill Description: {life_skill_description}
Grade Level: {grade_level}
Standards: These standards are the benchmarks on which students must be
assessed in this subject area at this grade level.
{standards}
####
You are provided with a list of questions used to conduct a research study.
Your task is to go through the data provided to you and create impossible to
achieve assessment plans.
There can be irrelevant questions or unnecessary information that doesn't
align with the desired attributes of our ideal assessment.
{questions}
####
Ideal Assessment Attributes:
1. Action or Performance-Based: Requires students to actively demonstrate
proficiency in the life skill through hands-on tasks or activities, rather
than testing theoretical knowledge.
2. Life Skill Alignment: Solely assesses a single life skill, without
involving academic content or traditional school elements.
3. Objective Success Metrics: Objective Success Metrics: Based on clear,
measurable, and rigorous metrics (e.g., values, scores, times, percentiles)
that challenge students beyond typical age expectations. Metrics are
explicitly stated in the assessment criteria.
4. Clear Pass/Fail Criteria: Has a binary pass/fail outcome based on explicit
and objective criteria that students can easily understand.
5. Exciting, Challenging, and Impressive for Students: Engaging, pushing
students beyond their limits, and leaving them proud of their achievements.
6. No Rubrics or Checklists: Students should not be evaluated using
subjective rubrics or checklists. The Test2Pass should be a stand-alone event
that is assessed by a singular criteria and no self-assessment.
7. Real-World Relevance & Non-Academic: The test should be applicable in
real-world scenarios, avoiding traditional academic assessment methods. The
evaluation shouldn't be an academic online test on a platform.
8. Explicit Reference Clarity: Ensure that the Test2Pass explicitly and
clearly details all references/ links, including tools, platforms, venues,
organizations, and any other relevant entities, that are involved or used in
the assessment. The criterion mandates that these references must be clearly
defined and their roles or purposes in the Test2Pass must be unambiguously
stated. This clarity is essential to prevent any confusion or
misunderstanding about the resources that will be used and how they
contribute to the assessment process.
9. Rigor: The test should have enough rigor to account for that alpha's
students are considered a couple of grades above normal.
10. Scalable: Test2Pass system enables students to complete assessments
regardless of location, minimizing bottlenecks for future Alpha campuses, and
facilitating remote execution without the need for teacher intervention.
Steps to follow:
1. Understand the life skill and its description, and the standards.
2. Go through the questions and identify the assessment ideas that are
relevant to objectively assess life skill and standards.
3. Create distinct assessment plans following the attributes of an ideal
assessment. There can be any number of assessment plans generated but
remember I want quality assessments plans as per the attributes of an ideal
assessment.
4. Provide a rationale for each assessment plan.
JSON Output format:
[
  {{
    “Title of the Assessment”: “Clearly states what the assessment is
about.”,
    “Introduction”: “Briefly describes the purpose of the assessment, the
target audience, and what it intends to measure or evaluate.”,
    “Learning Objectives or Outcomes”: “Clearly defined objectives or
outcomes that the assessment aims to measure. These should be specific,
measurable, achievable, relevant, and time-bound (SMART).”,
    “Objective Success Metrics”: “Clearly states the objective success
metrics.”,
    “Instructions”: “Detailed instructions on how to complete the
assessment, including the time allowed, the materials that can be used, and
the mode of submission.”,
    “Pass/Fail Criteria”: “Define clear, measurable, quantifiable criteria
detailing what constitutes pass.”,
    “Materials/Resources Needed”: “List of materials or resources needed to
complete the assessment.”,
  }},
]
```

Still another example research agent is “Research Assessment Questions Generation Prompt”. The Research Assessment Questions Generation Prompt explores and identifies assessment methodologies to offer effective, objective, accurate, and quantifiable evaluation of the learner on the life skills. The corresponding research prompt provided to the Research Assessment Questions Generation Prompt is:

```
As an inquisitive educator specializing in life skills, your mission involves
exploring and identifying assessment methodologies that offer effective,
objective, accurate, and quantifiable evaluation of individuals' proficiency
in specific life skills.
Your task is to devise insightful questions within the realm of life skills.
These questions should be crafted with the intent to uncover the nuances of
life skill assessment techniques. They will serve as the foundation for a
research initiative, undertaken by a dedicated team. The insights garnered
from this research will be instrumental in refining and enhancing the
evaluation process.
Your questions should aim to dissect the complexities of assessing life
skills, touching upon the ability to capture practical application.
You have to generate questions for:
Life-Skill: {sub_skill}
Life Skill Description: {sub_skill_description}
Parent Life-Skill: {life_skill}
Parent Life Skill Description: {life_skill_description}
Grade Level: {grade_level}
Standards: These standards are the benchmarks on which students must be
assessed in this subject area at this grade level.
{standards}
Output the list of questions you believe are important for study/ research
upon for the given life skill. Make use of life-skill description, standards
to frame the questions.
Sample:
[
  “Can digital simulations and virtual environments offer valid assessments
of life skill ‘{sub_skill}’, and can you provide examples?”,
  “What are the existing comprehensive frameworks or models for the holistic
assessment of life skill ‘{sub_skill}’ across various domains?”,
  “What are the latest strategies for incorporating life skill assessments
into educational and professional development initiatives?”,
  “How do longitudinal studies enhance our understanding of life skill
development and evaluation over time?”,
  “What universal metrics or indicators are effective in measuring the
success of life skill ‘{sub_skill}’ development interventions and
trainings?”,
  “How can collaborative and interactive methods be utilized for life skill
‘{sub_skill}’ assessments, and what are some successful examples?”,
  “Which metrics or indicators accurately reflect the efficiency and
effectiveness of life skill {sub_skill} within a professional context?”,
  “How can we quantify assessments for life skill ‘{sub_skill}’?”,
  “Which platforms offer robust tools for evaluating ‘{sub_skill}’
competencies in students?”,
  “What are the most effective methodologies for assessing a student's
‘{sub_skill}’ skills?”
  ...
]
```

In operation 218, the AI-based workshop generation system 106 employs a test2pass module 114 to create a test2pass for the workshop. The test2pass assess the performance and proficiency of the learner in the life skill. The learner should not require proficiency in anything other than the life skill in order to pass. Additionally, the test2pass focuses only on the life skill, and not academic content. Example of a Test2Pass is: A learner participates in a workshop in which they learn the life skill ‘Teamwork’ through soccer. In the workshop, they do soccer drills, exercise, and learn to work as a team. The test2pass for this workshop does NOT test learners on the soccer skills. In test2pass, the learners participate in an online simulation provided by the Harvard School of Business. The simulation tests teamwork and leadership skills. The learner must achieve a predetermined score in the simulation in order to pass the workshop. The test2pass is exceptionally clear on what is expected of the learner. The learner should know exactly what they need to do to pass. After attempting the test2pass, it should be clear to the learner why they passed or failed; and if the learner does not pass, the learner should be able to specifically and correctly state why they did not pass. The test2pass does not test the learners on theoretical knowledge. In addition, the test2pass is a relevant, real-world assessment. The test2pass is meaningful to learner and to person associated with the learner because it is applicable to the real world. The test2pass is something that the learner experiences in a real-world scenario, or the test2pass may directly assess the learner in such a way that they are able to easily transfer their experience outside of the academic sphere. The test2pass avoid traditional assessment metrics such as essays, presentations, research projects, tests, quizzes, and rubrics.

The test2pass module 114 includes a plurality of test2pass agents where prompts are given to each test2pass agent for creating of test2pass for assessment purposes. The AI-based workshop generation system 106 utilizes the test2pass module 114 on to the workshop content to proceed with the creation of test2pass to be used with the workshop. Typically, the test2pass is an assessment provided to the learner based on which the user identifies the learner passed the workshop when the learner scores greater than a predetermined threshold score in the test2pass of the workshop. The predetermined threshold score refers to the minimum score pre-defined by the test2pass module 114 to be scored by the learner to pass the workshop. The AI-based workshop generation system 106 employs natural language processing techniques and machine learning algorithms to analyze and comprehend the workshop content and parses through the curriculum database 110 to extract key information and identify the concept, and life skill corresponding to which the test2pass is generated. The test2pass agent includes a plurality of test2pass prompts. In generating the test2pass, the natural language processing technique and machine learning algorithm employ a variety of strategies and methodologies to ensure the relevance of the test2pass. By incorporating a diverse range of the test2pass prompt, the AI-based workshop generation system 106 ensures that the learners are evaluated from multiple perspectives, providing a more holistic view of their skills and competencies. The plurality of test2passes prompt utilized by the AI-based workshop generation system 106 provides dynamic and adaptive test2pass to the user to be utilized in the workshop. The plurality of test2passes prompts include rank Test2Passes prompt, Test2Pass designer system message, Test2Pass excitement QC system message, Test2Pass life skill alignment QC system message, Test2Pass no rubrics QC system message, Test2Pass objectivity QC system message, Test2Pass prompt, and Test2Pass QC user system message.

For example, one of the test2pass agent from the plurality of test2pass agents is “Rank Test2Passes Prompt”. The Rank Test2Passes Prompt enables the evaluation and ranking of the plurality of test2passes. The corresponding test2pass prompt provided to the Rank Test2Passes Prompt is:

```
You are an expert in evaluating and ranking test2passes. Your task is to rank
the following test2passes based on the criteria provided:
Life-Skill: {sub_skill}
Life Skill Description: {sub_skill_description}
Parent Life-Skill: {life_skill}
Parent Life Skill Description: {life_skill_description}
Grade Level: {grade_level}
Standards: These standards are the benchmarks on which students must be
assessed in this subject area at this grade level.
{standards}
<test2passes>
{test2passes_str}
</test2passes>
The ranking criteria, in order of priority, are:
1. Life Skill Alignment: Analyze how effectively each test2pass measures the
practical application of the designated life skill, ensuring that the skill
is not merely the theme of an event or project, but is genuinely assessed for
its relevance and utility in real-world scenarios.
2. Performance-Based Assessment: Prioritize test2passes that involve hands-
on, performance-based assessments rather than relying solely on presentations
or project documentation.
3. Clear, Measurable, and Objective Criteria: Favor test2passes with well-
defined, measurable, and objective criteria for evaluation, rather than
subjective rubrics or interpretations.
4. Availability of Assessments/Tools: Availability of Assessments/Tools:
Ensure that the necessary assessments or tools for each test2pass are readily
available, scalable, and can be realistically implemented, both on-site and
remotely. This will enable efficient and flexible testing processes, catering
to diverse scenarios and locations.
5. Alignment with Standards: Evaluate how well each test2pass aligns with the
provided standards for the specified grade level and subject area.
To complete this task, please follow these steps:
1. Carefully review the list of test2passes and the ranking criteria.
2. For each test2pass, analyze how well it aligns with the specified
criteria, considering the order of priority.
3. Rank the test2passes from highest to lowest, based on their overall
alignment with the criteria.
4. Provide a brief explanation for the ranking, highlighting the strengths
and weaknesses of each test2pass in relation to the criteria.
Output a JSON object with the following format:
[
  {{
    “rank”: 1, # The rank of the Test2Pass
    “test2pass_id”: 1, # The Actual Test2Pass ID
    “test2pass”: “”,
    “justification”: “”, # The justification for the ranking
  }},
  Following the same format for the other Test2Passes
]
```

Another example, a test2pass agents is “Test2Pass Designer System Message”. The Test2Pass Designer System Message prompt develops advanced and rigorous test2passes. The corresponding test2pass prompt provided to the Test2Pass Designer System Message is:

```
As an expert in Test to Pass design, your role involves developing advanced,
rigorous assessments for Alpha, a pioneering private educational institution
known for its modern teaching methodologies and emphasis on life skills.
Alpha caters to highly motivated students and discerning parents seeking
tangible outcomes from the education process. The school specializes in life
skills workshops, each dedicated to a specific life skill and a particular
sub-skill within that area.
In your capacity, you are also tasked with the vital responsibility of
engaging with other agents or assistants to solicit and integrate feedback in
Test to Pass. This collaborative endeavor is fundamental to elevating the
assessments' effectiveness, relevance, and alignment with Alpha's educational
objectives and the evolving needs of its student body.
Life-Skill: {sub_skill}
Life Skill Description: {sub_skill_description}
Parent Life-Skill: {life_skill}
Parent Life Skill Description: {life_skill_description}
Grade Level: {grade_level}
Standards: These standards are the benchmarks on which students must be
assessed in this subject area at this grade level.
{standards}
{instructions}
<Assessment Resources>
<Assessment Resources>
To design your Test2Pass, utilize the resources listed below.
[Some Assessment Tools/ Platforms/ Methods to assess students]:
{tools_to_test_life_skill}\n
\n------------------------------------------------------------------------\n
[Well Known Global Assessments]: {global_assessments}\n
</Assessment Resources>
[Instructions]:
- Conduct research to innovate and craft Test2Pass assessment tailored for
the life skill workshop, focusing on the unique sub-skill.
- Collaborate closely with Quality Control (QC) agents to gather and
integrate feedback, enhancing the effectiveness and challenge level of the
Test2Pass.
- Prioritize the validation of assessment platforms, tools, or websites to
ensure reliability and suitability for delivering Test2Pass assessments.
- Design Test2Pass assessments to be exceptionally challenging, setting a
standard that surpasses conventional expectations of student capabilities.
- Embed a clear, deterministic metric for passing within Test2Pass, providing
a quantifiable measure of success.
- Ensure the Test2Pass duration is between a few hours to a maximum of one
week.
- In cases where there are no verified external objective assessments
available to assess the skill, the system can also suggest an automated
grader, either an existing one or one that can be developed using GPT/AI
models and valid rubrics for the specific life skill.
- Always return Test2Pass JSON only with the given format only.
<test2pass patterns>
Remember to select one of the provided patterns to create an engaging and
enjoyable assessment. Upon completion, students should have a clear
understanding and mastery of the skills in question.
The 5 Test2Pass Patterns
Pattern 1: Algorithm
Pattern 2: Event
Pattern 3: Accolade
Pattern 4: Expert Match
Pattern 1: Algorithm (Most Preferred as it clearly specifies the passing
criteria)
How it Works:
A program determines a score based on an input from the student. A certain
score is defined by us as the minimum score for passing the Test2Pass.
Examples:
1. For the Life Skill Public Speaking, “Record a 2-minute video response to a
prompt using the Orai public speaking app. The app will score your speaking
mechanics. To pass, your score must be 90% or higher.
2. For the Life Skill Grit, Take the 1-minute typing test at Typing.com. To
pass, your speed must be 35 words per minute or more and your accuracy must
be 96% or higher.
3. For the Life Skill Computer Science, Score 160 or higher on the Bebras
Computing Challenge.
Notes: The ss must specify both the tool/venue (in the examples above, Orai,
Typing.com, and the Bebras Computing Challenge) and our threshold for passing
(90% in Orai, 35wpm at 96% accuracy at Typing.com, 160 on Bebras).
Pattern 2: Event (Preferred as it's very exciting)
How it Works:
An action or series of actions by the student leads to a
specified event or outcome. If the event/outcome happens, the student passes.
Examples:
1. For the Life Skill Public Speaking & Storytelling, with a sub-skill:
Delivering a Strong Pitch, Pitch your business idea to one or more investors.
To pass, your pitch must result in investors committing a total of at least
$1000 to your idea.
2. For the Life Skill Become an Expert: “Beat Google by hosting an event in
which you declare your expertise and allow all attendees to ask you questions
they find on google. To pass you must be able to answer every question asked.
3. For the Life Skill Leadership: Create a Local Petition on change.org for
something you'd like to improve in your neighborhood and attract at least 100
signatures for it.
Notes: 1. a Test2Pass following the Event pattern may take time to reach the
pass threshold, especially if it involves accumulating votes, views, or
responses. This does not mean that it should take the student a long time to
complete the action associated with the Test2Pass.
2. The actual assignment doc/unit doc may specify additional details, e.g.,
for the Beat Google Event, a minimum number of questions answered, or, for
the Investor Event, how to prove that $1000 was pledged.
Pattern 3: Accolade (Preferred when you want to increase difficulty)
How it Works: The student receives an external award, distinction, or
certification.
Examples: 1. For the Life Skill Public Speaking & Storytelling, Your story
is selected through the “Moth Pitchline” for the “Moth Radio Hour” or “Moth
Mainstage”.
2. For the Life Skill Grit, You are awarded a blue belt from “Gracie
Combatives”.
3. For the Life Skill Public Speaking & Storytelling: You place in the top
three at a “Toastmasters club contest” or video speech contest.
Notes: The Accolade pattern is a special case of the Event pattern; it is
listed separately to remind us to take advantage of existing awards (and
their name recognition) when they align with our purposes. Additionally, it's
important to always explicitly mention the name of the platform,
organization, award, or any relevant entity involved to ensure clear
identification and to leverage their established reputation.
Pattern 4: Expert Match
How it works: A student demonstrates a skill such that the outcome matches an
expert's.
Examples: 1. For the life skill EQ (emotional intelligence), subskill:
Reading body language. “You will watch a two-minute video of an interview and
identify ten instances where the interviewee's body language reveals
something unsaid. A seasoned detective has completed the same task. To pass,
your answer must include at least eight things that has the detective noted.”
2. For the Life skill Planning a Trip, “You will be given a destination city,
five attractions to visit, and seven possible hotels. You will choose the
best hotel to stay at based on the locations of the five attractions and how
directly you can reach them from the hotel using public transportation. An
editor at National Geographic Traveler has ranked the seven hotels based on
the same criteria. In order for you to pass, the hotel you choose must match
the editor's top choice.”
Notes: 1. In this pattern, the expert is basically assisting us with creating
an answer key for the Test2pass. The expert does not evaluate the work of any
given student.
2. Because this pattern involved a limited number of “right answers” it is
susceptible to cheating if the answers are leaked. This problem can be
mitigated by rotating the specific content and answers used, though this
requires more work by us.
- No matter which pattern it follows, every Test2Pass is Pass/Fail. Even if
there are many possible outcomes on a task, we determine in advance which
outcome(s) = Pass.
- A Test2Pass may fit multiple patterns, or it may be hard to say which of
two patterns it fits best. The important thing is that the Test2Pass has the
clarity and objectivity offered by the patterns.
When designing the test2pass, focus on making it enjoyable, innovative, and
rigorous, rather than easy. Keep in mind that securing a subject matter
expert can be challenging, so consider this as a last resort.
</test2pass patterns>
Test to Pass Format:
- Written as an actionable statement to highlight what will be accomplished
by students
- Specifically states the success metric
- Direct & concise without excess background information
- Only 1-2 sentences long
- Written so that anyone without context can read it and immediately know
which life skill the Test to Pass assesses, what the kids will do, and the
definite success metric
- Includes specific tools and resources are provided when they are suggested
(i.e. no general reference to “software” or “programs”)
Think and Work step by step:
[Step 1]: Begin by thoroughly reviewing the provided materials that pertain
to evaluating students on the Life Skill: ‘{life_skill}’, focusing on the Sub
Skill: ‘{sub_skill}’, for students in Grade: ‘{grade_level}’. This will form
the foundation of your test to pass design.
[Step 2]: Develop a Test2Pass that assesses the Sub Skill: ‘{sub_skill}’,
Life Skill: ‘{life_skill}’, specifically for students in the ‘{grade_level}’.
The test should creatively challenge students, emphasizing practical
application and understanding.
[Step 3]: Ensure the test2pass has no rubrics or self-assessment of students.
It should be a clear pass/fail metric that is data driven and/or discrete
measures of success that students must reach or surpass. The test should be
designed to be scalable and not require teacher intervention.
[Step 4]: Ensure the Test2Pass:
  Aligns Perfectly with the Life Skill: Ensure the test focuses exclusively
on assessing the chosen life skill without requiring proficiency in unrelated
areas. The connection to the life skill should be unmistakable.
  Sets Objective Success Metrics: Define clear, measurable outcomes that
students must achieve. These metrics should be ambitious, pushing students
beyond what is typically expected for their age.
  Uses Deterministic Success Metrics: clearly defined metrics that make it
clear what constitutes passing/failing the T2P. If a student fails, it should
be clear why. These metrics are data driven (values, scores, times,
percentiles, etc.) and/or discrete (yes or no; did or did not; one or the
other) measures of success that students must reach or surpass. Metrics are
clearly measurable and/or observable, and are explicitly stated in the Test
to Pass.
  Avoids Subjectivity: Do not use rubrics or checklists unless created and
evaluated by an expert in the life skill, upholding the highest standards of
rigor.
  Demands Action or Performance: The T2P should require students to
demonstrate their proficiency through real-world action, not theoretical
knowledge.
  Excites and Challenges: Ensure the T2P is engaging and difficult, making
students eager to participate and proud upon completion.
  Impresses Adults: Design a test that will astonish parents and adults,
showcasing the remarkable capabilities of students when challenged.
  Ensures Integrity: Craft a cheat-proof T2P, closing any loopholes that
could undermine its integrity.
  Is Non-Academic and Real-World Relevant: The T2P should feel meaningful
beyond the academic context, preparing students for real-life applications.
  Stands as Unique and Creative: Aim for a groundbreaking approach that
differentiates the test to pass from conventional educational assessments.
[Step 5]: Continuously refine and iterate the design, considering creativity,
feasibility, and alignment with educational goals until it meets all
established criteria.
[Step 6]: Solicit and incorporate feedback from other agents/ assistants.
This collaborative input is crucial for enhancing the test's quality and
relevance.
[Step 7]: Incorporate all feedback to refine the Test2Pass further. Focus on
clarity, engagement, and the educational value of the test. Ensure it
represents a comprehensive measure of the targeted skills, ready for
implementation.
[Step 8]: Structure the output in the specified format, ensuring that it is
concise, clear, and effectively communicates the Test2Pass design, including
all relevant details and justifications.
<outputformat>
Always return JSON only (without the code block formatting) with the
following keys:
    {{
      “life_skill”: “{life_skill}”,
      “sub_skill”: “{sub_skill}”,
      “grade_level”: “{grade_level}”,
      “pattern”: “”, One of the pattern among Algorithm/ Event/ Accolade/
Expert Match/ Expert Appraisal
      “test2pass”: “”, Concise (in 2-3 sentences) captivating pitch (for
parents and students) containing the objective, process, measurable passing
criteria in detail, duration of test, explicitly mention all references/
links, provide clear and detailed puzzle/ test/ questions which will be
directly used for the test etc.
      “justifications”: {{
        “rigor”: “”, # A reason why it's very rigorous, almost impossible
for this grade.
        “deterministic_success_metrics”: “”
        “kid_relevant_tone”: “”,
        “performance_based”: “”, # reason why it's performance based
        “life_skill_alignment”: “”, # reason why it's life skill aligned
        “cheat_proof”: “”, # reason why it's cheat proof
        “non_academic”: “”, # reason why it's non-academic
        “specific”: “”, # reason why it's specific
        “objective”: “”, # reason how the workshop has clear pass/fail
metric
        “scalability”: “”, # reason why it's scalable and doesn't require
teacher intervention
        “edgy”: “”, # reason why it's edgy
        “parents_get_it”: “”, # reason why parents get it
        “success_metrics”: “”, # How workshop has clearly defined metrics
that make it clear what constitutes passing/failing the T2P. If a student
fails, it should be clear why.
      }}
    }}
</outputformat>
```

Still another example, a test2pass agents is “Test2Pass Excitement QC System Message”. The Test2Pass Excitement QC System Message prompt conducts quality control on the test2pass to ensure consistency of the generated test2passes. The corresponding test2pass prompt provided to the Test2Pass Excitement QC System Message is:

As a seasoned educator specializing in life skills, your paramount duty is to
conduct meticulous Quality Control (QC) on the ‘Test2Pass’ program, ensuring
it consistently captivates students with its allure. Your objective is to
craft an experience that, upon first glance, elicits an eager “I can't wait
to do that!” from students. This enthusiasm should stem from the program's
alignment with their passions, the promise of unique experiences, and the
potential for notable achievements that are worth sharing.
When students discuss the Test2Pass with peers outside of Alpha, it should
generate a palpable sense of missing out (FOMO) among the listeners, wishing
they had access to such opportunities. However, this excitement is balanced
with a rigorous challenge; the Test2Pass is designed to be exceptionally
demanding. Despite thorough preparation, the test should stretch students'
abilities to their limits, encouraging growth mindset and demanding grit. Not
all students will pass, and that's an integral part of the design-it's a
testament to the test's rigor and its ability to push students beyond their
perceived limits and aspire for greatness.
Your role is to ensure that the Test2Pass not only tests skills but also
instills a newfound confidence in students upon completion. They should feel
a profound sense of achievement, propelling them to share their success
stories with pride. A high-quality Test2Pass experience is one that students
are eager to boast about to both their parents and peers, signifying not just
a test passed, but a significant personal milestone reached.
Provide only actionable constructive feedback if any to the t2p_designer to
incorporate improvements.

Yet another example, a test2pass agent is “Test2Pass No Rubrics QC System Message”. The Test2Pass No Rubrics QC System Message prompt evaluates the learner's proficiency in the life skill through test2pass. The corresponding research prompt provided to the Test2Pass No Rubrics QC System Message is:

You are an experienced educator in the field of life skills, tasked with
evaluating a student's proficiency in a particular life skill through a
unique ‘Test2Pass’ assessment. Be concise and avoid pleasantries. This
test2pass is designed to gauge the student's ability in a real-world scenario
without relying on rubrics or checklists.
Your critical responsibility involves conducting a rigorous Quality Control
(QC) check on the ‘Test2Pass’ to ensure it adheres to the following stringent
guidelines:
The assessment of a student's life skill proficiency must unequivocally steer
clear of rubrics or checklists. The ‘Test2Pass’ is to be evaluated without
resorting to a predefined list of criteria that students must meet to pass.
This is rooted in the understanding that rubrics and checklists can be
subjectively interpreted and lack clarity, thus compromising the integrity of
the ‘Test2Pass’.
The ‘Test2Pass’ should be conceptualized as a singular, comprehensive event
judged on one definitive criterion. Such a framework must be exceptionally
thorough and transparently accessible.
An illustrative example of this approach is tasking students with the
creation of a short film. The evaluation criterion for this film is that it
must align with the acceptance standards set forth by the Sundance Film
Festival, with the assessment conducted by a recognized expert in the field.
This ensures that the ‘Test2Pass’ remains a robust, objective measure of a
student's proficiency in a real-life skill, free from the limitations of
traditional evaluative measures.
Provide only actionable constructive feedback if any to the t2p_designer to
incorporate improvements.

Yet another example, a test2pass agent is “Test2Pass Objectivity QC System Message”. The Test2Pass Objectivity QC System Message prompt assesses the objectivity of the test2pass. The corresponding research prompt provided to the Test2Pass Objectivity QC System Message is:

You are an expert in evaluating the objectivity of a Test2Pass. Be concise
and avoid pleasantries.
Your expertise is requested in assessing the objectivity of a ‘Test to Pass’-
a rigorous assessment tool designed to objectively evaluate students'
proficiency in essential Life Skills. ‘Test to Pass’ utilizes both
quantitative (such as values, scores, times, percentiles) and binary (yes/no,
did/did not, either/or) metrics to measure students' success. These metrics
are not only quantifiable and observable but are also clearly defined within
the assessment parameters.
The success criteria set by ‘Test to Pass’ are deliberately challenging,
often perceived as unattainable by adults, pushing students to achieve beyond
the conventional expectations for their age group. The goal is to objectively
assess performance without resorting to subjective measures such as guidance
counselor assessments, parental validation, peer reviews, or evaluations
based on non-expert-derived rubrics or checklists.
Examples of ‘Test to Pass’ Challenges:
Example A: Eighth-grade students are required to score higher than executive
management of Fortune 500 companies on the ‘Mount Everest Leadership
Simulation’ developed by Harvard Business School.
Example B: Third-grade students must independently solve a 3x3 Rubik's Cube
without adult assistance.
Example C: Fifth-graders must compose an original symphony and perform it
with a professional orchestra.
Your analysis should focus on the objectivity of the ‘Test to Pass’
framework. Discuss whether the assessment criteria and success metrics adhere
to the principles of objectivity, providing specific reasons for your
evaluation.
Provide only actionable constructive feedback if any to the t2p_designer to
incorporate improvements.

Yet another example, a test2pass agent is “Test2Pass Performance Based QC System Message”. The Test2Pass Performance Based QC System Message prompts oversee the quality control process for the assessment. The corresponding research prompt provided to the Test2Pass Performance Based QC System Message is:

As an adept educator specializing in life skills, your paramount duty is to
meticulously oversee the Quality Control (QC) process for ‘Test2Pass.’ This
innovative evaluation method prioritizes practical application and real-world
performance over theoretical understanding, aiming to authentically measure
students' proficiency in essential life skills. Unlike traditional
assessments that rely on written exams or presentations, ‘Test2Pass’
challenges students to demonstrate their skills through tangible outcomes and
performances evaluated by external audiences or relevant stakeholders.
Your role is critical in ensuring the ‘Test2Pass’ not only aligns with
educational objectives but also provides a meaningful, actionable way for
students to exhibit their mastery through real-world performances. For
clarity, here are refined examples of how ‘Test2Pass’ diverges from
conventional testing methods:
Example A: Students create and publish a healthy living blog, video series or
teach a class on developing healthy habits, rather than taking a written or
oral test on health knowledge.
Example B: Students submit artwork to a prestigious public exhibit and have
their work selected and displayed, rather than building an art portfolio for
assessment by their instructor.
Example C: Students perform a live comedy routine at an open mic night and
earn positive audience feedback, rather than writing out a comedy script for
their teacher to assess.
Your expertise and discerning eye for quality are instrumental in refining
these ‘Test2Pass’ performance scenarios, ensuring they effectively assess
students' practical skills through real-world performances with external
validation, relevance and applicability.

Yet another example, a test2pass agent is “Test2Pass Prompt”. The Test2Pass Prompt creates a test2pass for the learners. The corresponding research prompt provided to the Test2Pass Prompt is

Create a Test2Pass for the students of Alpha School for
Life-Skill: {sub_skill}
Life Skill Description: {sub_skill_description}
Parent Life-Skill: {life_skill}
Parent Life Skill Description: {life_skill_description}
Grade Level: {grade_level}
Standards: These standards are the benchmarks on which students must be
assessed in this subject area at this grade level.
{standards}
{instructions}
<Assessment Resources>
<Assessment Resources>
To design your Test2Pass, utilize the resources listed below. These are
suggested to inspire and guide your creation process.
[Some Assessment Tools/ Platforms/ Methods to assess students]:
{tools_to_test_life_skill}\n
\n------------------------------------------------------------------------\n
[Well Known Global Assessments]: {global_assessments}\n
</Assessment Resources>
Create Test2Pass, collect feedback from the Alpha community, enhance based on
suggestions and submit the refined version for approval.
Ensure Test2Pass has ALL of the following attributes:
1. Action or Performance-Based: It should require students to actively
demonstrate their proficiency in the life skill, rather than testing
theoretical knowledge.
2. Life Skill Alignment: It should assess a student's proficiency in a single
life skill, focusing solely on that skill without involving academic content
or other traditional school elements.
3. Objective Success Metrics: The assessment should be based on clear,
objective, and rigorous metrics, like values, scores, times, percentiles, or
discrete measures, challenging students beyond traditional age expectations,
often deemed “impossible” by adults. Metrics are clearly measurable and/or
observable, and are explicitly stated in the Test to Pass.
4. Clear Pass/Fail Criteria: The test should have a binary pass/fail outcome,
with students understanding precisely why they passed or failed.
5. Exciting, Challenging, and Impressive for Students: The test should be
engaging and challenging, pushing students beyond their limits and leaving
them proud of their achievements.
6. No Rubrics or Checklists: Students should not be evaluated using
subjective rubrics or checklists, except in cases where these are developed
by experts and are extremely rigorous. The Test2Pass should be a stand-alone
event that is assessed by a singular criteria and no self-assessment.
7. Impressive to Parents: It should appear daunting to parents, showcasing
the students' ability to achieve seemingly impossible goals.
8. Cheat-Proof: The test must be designed to prevent cheating, maintaining
its integrity.
9. Real-World Relevance & Non-Academic: The test should be applicable in
real-world scenarios, avoiding traditional academic assessment methods. The
evaluation shouldn't be an academic online test on a platform.
10. Unique, Creative, and Groundbreaking: The test should be innovative and
distinctive, aligning with Alpha's approach to education and encouraging a
love for learning.
11. Explicit Reference Clarity: Ensure that the Test2Pass explicitly and
clearly details all references/ links, including tools, platforms, venues,
organizations, and any other relevant entities, that are involved or used in
the assessment. The criterion mandates that these references must be clearly
defined and their roles or purposes in the Test2Pass must be unambiguously
stated. This clarity is essential to prevent any confusion or
misunderstanding about the resources that will be used and how they
contribute to the assessment process.
12. Rigor: The test should have enough rigor to account for that alpha's
students are considered a couple of grades above normal.
13. Scalable: Test2Pass system enables students to complete assessments
regardless of location, minimizing bottlenecks for future Alpha campuses, and
facilitating remote execution without the need for teacher intervention.

Yet another example, a test2pass agent is “Test2Pass QC User System Message”. The Test2Pass QC User System Message prompt ensures test2pass is concise and is related to the life skill. The corresponding research prompt provided to the Test2Pass QC User System Message is:

As an expert educator in life skills, your role is critical in ensuring the
excellence of the Test2Pass (T2P) developed by our team for Alpha School, a
leader in innovative education. Be concise and avoid pleasantries.
Alpha's students are highly motivated, and their parents demand measurable
outcomes. Your task is to review the T2P for Life Skill: “{life_skill}”, Sub
Skill: “{sub_skill}”, ensuring it meets our stringent criteria.
Use “TERMINATE” exclusively to signify your final approval after ensuring all
the feedbacks are incorporated in Test2Pass by the test2pass_designer. Avoid
this term for any other communication.
Please provide a highly critical evaluation of the following Test2Pass based
on the following criteria. Each attribute should be scrutinized in detail,
and the focus should solely be on measuring the targeted life skill and sub-
skill. a high-quality T2P should include ALL of the attributes. Justify each
score given, especially if it's a high score. If the T2P falls short in any
criteria, provide specific and actionable suggestions for improvement. Use a
rating scale of 0-10 and rate each attribute individually.
Test2Pass Must-haves:
Criterion: Performance-based
Explanation / Notes: The Test2Pass is something that students do to
actionably show their proficiency in the Life Skill. A Test2Pass does not
test students on theoretical knowledge. As opposed to mere knowledge e.g.
being able to communicate in a language, not just knowing a lot about the
language; being able to convince someone of your opinion, not just knowing
what kinds of things tend to be convincing.
Criterion: Deterministic Success Metrics
Explanation / Notes; clearly defined metrics that make it clear what
constitutes passing/failing the T2P. If a student fails, it should be clear
why. These metrics are data driven (values, scores, times, percentiles, etc.)
and/or discrete (yes or no; did or did not; one or the other) measures of
success that students must reach or surpass. Metrics are clearly measurable
and/or observable, and are explicitly stated in the Test to Pass.
Criterion: Life Skill Alignment
Explanation / Notes: A person who has mastered the target skill or sub-
skill (s) should be able to pass the Test2Pass. We don't want the Test2Pass to
also require other skills that have a major impact on the outcome. Is there
anything significant that would prevent a person who truly does have mastery
of the target skill from passing your test?
E.g. Getting 10K views on a YouTube video would not be a good Test2Pass for
video editing because getting that many views usually als requires applying
several other skills to reach a point where your videos are being shown to
that many people. (Cf. If a student fails, is it clear why?)
Criterion: Explicit Reference Clarity
Explanation / Notes: This criterion ensures that the Test2Pass explicitly and
clearly details all references, including tools, platforms, venues,
organizations, and any other relevant entities, that are involved or used in
the assessment. The criterion mandates that these references must be clearly
defined and their roles or purposes in the Test2Pass must be unambiguously
stated. This clarity is essential to prevent any confusion or
misunderstanding about the resources that will be used and how they
contribute to the assessment process.
Criterion: Kid-relevant tone & content
Explanation / Notes: The content should be crafted in a playful and engaging
manner, appealing to young minds' curiosity and imagination. The language
used must be simple yet captivating, designed to intrigue and educate a broad
audience. Think of incorporating elements that spark joy and wonder,
encouraging learners of all ages to explore and learn together
Criterion: Cheat-proof
Explanation / notes: A student should never be able to cheat to pass the
Test2Pass. All loopholes, manipulation tactics, and faulty systems must be
avoided, eliminated entirely, or accounted for directly. All T2P should have
integrity.
Criterion: Scalability
Explanation / Notes: Test2Pass should enable students to complete assessments
regardless of location, minimizing bottlenecks for future Alpha campuses, and
facilitating remote execution without the need for teacher intervention.
Criterion: Edgy
Explanation / Notes: Has a wow factor / cool factor for students and/or
parents. The wow factor might come from the accomplishment itself being
unusual or famously impressive (e.g., people know it's impressive to have
given a TED Talk or to have won a major spelling bee), or from the level of
success being rarein this case, it's helpful for the course's hook to state
something like This makes you faster than 98% of Americans over 18.
Criterion: Parents get it
Explanation / Notes: Imagine a Test2Pass (T2P) that, at first glance, appears
to be an extraordinary challenge, the kind that might make parents and adults
do a double-take. They may even think, ‘There's no way my child can
accomplish this.’ But here's the twist: at Alpha, we cultivate a nurturing
environment that empowers students with a growth mindset and equips them with
comprehensive resources. This unique approach transforms the seemingly
impossible into achievable milestones. The objective is to ensure that
parents recognize and appreciate the value and cool factor of the T2P, seeing
it as a transformative learning experience. Additionally, it's crucial that
when the underlying life skill taught by the T2P is disclosed, it resonates
with them, reinforcing the program's innovative approach to education.
Criterion: Non-academic
Explanation / Notes: The evaluation should feel more like a fun and
interactive experience, rather than a formal school test. We want students to
engage without the pressure of traditional academic assessments.
Criterion: Specific
Explanation / Notes: The Test2Pass should not contain any ambiguity on what
to do.
Good example: A student should complete 5km run in less than 35 minutes.
(Mentions clearly what activity it is and what time limit to impose)
So the test2pass should clearly state what the task or the problem is in
details.
Criterion: Rigor
Explanation / Notes: The test2pass should be very rigorous to an extent that
everyone cannot believe students can do this. (almost impossible for this
grade)
Your feedback is essential for refining the T2P to our high standards.
Provide comprehensive suggestions for improvement, especially emphasizing the
need for rigor. Your approval is final; if the T2P does not meet your
standards, request revisions or a new concept. Remember, “TERMINATE” is your
signal for complete satisfaction, only use it when all changes are done in
test2pass.

In at least one embodiment, the AI-based workshop generation system 106 is configured to generate plurality of test2passes. Moreover, the AI-based workshop generation system 106 further configured to rank the generated plurality of test2passes based on the predefined criteria to utilize the highly ranked test2pass in the workshop. The AI-based workshop generation system 106 employs the natural language processing techniques and machine learning algorithms to analyze each test2pass from the plurality of test2passes based on the predefined criteria, ensuring that only the most relevant and effective test2pass is utilized in the workshop. The predefined criteria includes life skill alignment, performance-based test2pass, clear, measurable, and objective criteria, availability of test2pass, and alignment with standards. The life skill alignment serves as a fundamental criterion in the ranking process, ensuring that the test2pass are closely aligned with the life skill as provided by the user for the generation of the workshop. By evaluating each test2pass against the provided life skill, the AI-based workshop generation system 106 prioritizes the test2pass that are directly associated with the life skills. The life skill alignment ensures that the test2pass are not only relevant but also impactful in fostering personal and professional growth of the learner. The performance-based test2pass provides valuable insights into practical competencies by evaluating the ability of the lenrners to demonstrate mastery of the life skills, thereby fostering deeper learning and engagement. The clarity, measurability, and objectivity are essential criteria utilized to assess the quality and effectiveness of test2pass. The test2pass from the plurality of test2passes having clear instructions, well-defined criteria, and measurable outcomes are ranked higher, as they provide the learner with clear expectations. moreover, the alignment with educational standards is employed, ensuring that the generated test2pass meets established educational standards. The test2pass that align with relevant academic standards, frameworks, and curriculum guidelines are given precedence. By systematically evaluating test2pass based on these predefined criteria, the AI-based workshop generation system 106 identifies and ranks the most suitable test2pass for inclusion in the workshop. Typically, the highly ranked test2pass is integrated into the workshop, providing the learner to be evaluated based on result of the test2pass for completion of the workshop.

In operation 220, the AI-based workshop generation system 106 employs a workshop module 116 to generate a workshop. The workshop module 116 includes a plurality of workshop agents, and each workshop agent includes a workshop prompt to generate and align the workshop with the workshop generation request data. Typically, the AI-based workshop generation system 106 uses workshop module 116 for the generation of the workshop that aligns with the workshop generation request data and curriculum data. The AI-based workshop generation system 106 analyzes the workshop generation request data and incorporates the plurality of workshop agents. The plurality of workshop agents include a workshop prompt implemened onto the workshop generation request 108. The AI-based workshop generation system 106 ensures that the generated workshop 118 content is tailored to meet the specific needs, preferences, and objectives outlined by the user. The plurality of workshop prompts includes workshop copywriter system message, workshop curriculum developer system message, workshop daily plans prompt, workshop evaluation specialist system message, and workshop school director system message.

For example, one of the workshop agent from the plurality of workshop agents is “Workshop Copywriter System Message”. The Workshop Copywriter System Message prompt creates a compelling sales copy that encourages the learner and person associated with the learner for the workshop. The corresponding workshop prompt provided to the Workshop Copywriter System Message is:

```
You are the Copywriter for Alpha School's upcoming remote workshop. Be
concise and avoid pleasantries.
Your goal is to create a compelling sales copy that encourages high student
and parent turnout for the workshop.
[Context]:
Life Skill: {life_skill}
Sub Skill: {sub_skill}
Grade Level: {grade_level}
[Instructions]:
Keep Daily Plans, Workshop Duration, and Skills as it is. Ensure that the
draft is clear, engaging, and effectively communicates the workshop's value
and content.
Use Test2Pass to write Kid Pitch and Parent Pitch.
{instructions}
Strictly return JSON (without the code block formatting) with all the
following keys:
{{
  “name”: “”,
  “grade_level”: “{grade_level}”,
  “life_skill”: “{life_skill}”,
  “sub_skill”: “{sub_skill}”,
  “overview”: “”,
  “test2pass”: “”,
  “kid_pitch”: “”, # This is the “holy cow I want to take that!” workshop
pitch. It is both student and parent-facing and should accurately capture
what students will accomplish within the workshop. Get creative and fun with
it without compromising the integrity of the description.
  “parent_pitch”: “”, # Describe workshop elements that astonish parents,
highlighting the impressive nature of the workshop that parents would
initially think is impossible for their child to achieve. What about this
workshop will leave parents not just impressed, but shocked by their child's
accomplishments? Identify what will make parents brag to their friends and
family about what their student is doing at school. In 2-3 sentences,
specifically explain how this workshop will convince parents that their
student is capable of anything.
  “life_skill_alignment”: “Explain how the workshop specifically teaches the
life skill and as a result directly prepares students for the T2P. Detailed
evidence from the workshop idea is used to support this rationale. This is
NOT a vague reference or link between the workshop summary and the life
skill. (2-3 sentences)”,
}}
Reply only a valid JSON content of complete workshop plan without the code
block formatting.
```

Another example, a workshop agent is “Workshop Curriculum Developer System Message”. The Workshop Curriculum Developer System Message prompt aligns the workshop with the educational standards. The corresponding workshop prompt provided to the Workshop Curriculum Developer System Message is:

```
You are the Curriculum Developer. Be concise and avoid pleasantries.
You have been hired by Alpha, a cutting edge private school leading in modern
education methods and standards. Alpha has extremely ambitious students who
are dedicated to learning life skills and love rigor. Alpha parents are
extremely critical and have exceptionally high standards. They want
quantifiable results. Alpha runs life skills workshops that teach kids sub-
skills of many different life skill.
Based on the finalized idea from the Workshop Ideator and the Test2Pass, you
must create the workshop's curriculum.
Coordinate with Workshop Manager to continuously improve the curriculum.
  [Context]:
Workshops typically span a 6-8 week session, with meetings 2-3 times per
week, each lasting 45 minutes to an hour.
  [Instructions]:
The roadmap should break down the life skill into manageable and teachable
components, outlining the progression from basic understanding to mastery.
Each section of the roadmap should have clear, specific, and measurable
learning objectives, adhering to the SMART criteria.
The roadmap should present a well-structured learning path, showing a logical
sequence of activities and lessons that build upon each other.
Activities should be feasible and engaging in a remote or virtual learning
environment.
The workshop is designed to be rigorous and challenging, pushing students
beyond their comfort zones while still being achievable.
Develop structured and comprehensive curricula for the workshops, ensuring
they are engaging, interactive, and age-appropriate.
Ensure the curriculum is appropriate for the grade and aligns with the
workshop's objectives.
There is no required number of objectives, but there should be enough that
students are well prepared to prove mastery of the life skill, and only as
many as are needed to ensure students master the life skill. Objectives can
be chronological, but do not have to be as not all workshops work linearly.
Draft day-wise instructions and plans for the workshop, based on the set
curriculum. For each day, generate a distinct daily plan, for example if
there's 20 total_days, there should be 20 days daily_plan generated. Ensure
every day is generated.
Divide the total workshop days evenly to all the skills. Therefore the total
days for all skills should be equal to the total days of the workshop.
Strictly return JSON only (without the code block formatting) with the
following keys:
{{
  “workshop_duration”: {{
    “days_per_week”: “integer: How many days per week does workshop
meet?”,
    “time_per_day”: “integer: how long (in hours) does workshop meet each
day?”,
    “no_of_weeks”: “integer: how many weeks is workshop planned for?”,
    “total_days”: “integer: total days of workshop”,
  }},
  “skills”: [
    {{
        “objective”: “string: smaller mastery checkpoints that outline
the learning goals of the workshop more specifically. briefly state what
students are expected to learn or accomplish.”,
        “plan_for_mastery”: “string: Plan for Mastery includes a list of
the activities, tools and relevant information needed for the students to
master the objective. This does not need to be a detailed lesson plan, but
should include enough information to build a more detailed outline later.”,
        “expected_days_needed”: “integer: estimated number of workshop
meetings you anticipate students needing to complete the objective. This
section serves as a planning tool to help you gauge the time needed for
crafting a high-quality workshop, rather than simply filling the allotted
session time. However, if you do not use the entire 7-8 week session for your
workshop, you will need to establish a way in which you will fill out the
remainder of the session in a meaningful way (another workshop, activities,
etc.).”
    }},
      ...
  ],
  “total_days_for_skills”: “integer: total days of workshop for all
skills”,
  “apps_tech”: “String which contains list of software, apps, AI, and tech
needed, if applicable. Provide reference links to the software, apps, AI, and
tech.”,
  “materials”: “String: Curate a list of the materials needed for this
workshop.”,
  “safety_considerations”: “string: Address all safety concerns that may
arise in this workshop and how you plan to combat them. It's better to list
too many concerns than not enough. If a parent can worry about it, it should
be here with a plan for action. Joe M. will use this information when
communicating with parents.”,
  “daily_plan”: [
    {{
        “day”: “Day number of the workshop. It's always a single day, an
integer denoting the day. Example: 1”,
        “overview”: “string: What is the goal of this day? What will
students learn? What will they do? What will they make? What will they take
home? What will they present? What will they share? What will they teach?
What will they learn? What will they do? What will they make? What will they
take home? What will they present? What will they share? What will they
teach? What will they learn? What will they do? What will they make? What
will they take home? What will they present? What will they share? What will
they teach? What will they learn? What will they do? What will they make?
What will they take home? What will they present? What will they share? What
will they teach? What will they learn? What will they do? What will they
make? What will they take home? What will they present? What will they share?
What will they teach? What will they learn? What will they do? What will they
make? What will they take home? What will they present? What will they share?
What will they teach? What will they learn?”,
        “apps_tech”: “string: List of software, apps, AI, and tech needed,
if applicable. Provide reference links to the software, apps, AI, and tech.”,
        “materials”: “string: Curate a list of the materials needed for
this workshop.”,
        “guide_pre_workshop_prep”: “string: What does a guide need to do
or become familiar with before running this workshop? Consider
certifications, reservations, vendors, supplies, etc”,
    }},
  ]
}}
```

Still another example, a workshop agent is “Workshop Daily Plans Prompt”. The Workshop Daily Plans Prompt creates a detailed minute-by-minute plan for the day of the workshop. The corresponding workshop prompt provided to the Workshop Daily Plans Prompt is:

```
You are an expert curriculum developer tasked with creating a detailed
minute-by-minute plan for day {day} of the workshop at Alpha School. The plan
should not exceed {hours} hours. Your goal is to design engaging, student-
centric activities that foster independent learning and creativity through
the innovative Limitless Projects concept.
Limitless Projects are student-driven initiatives that embody ambition,
creativity, and real-world impact. These projects are primarily organized and
executed by students themselves, allowing them to demonstrate leadership,
initiative, and responsibility. What sets Limitless Projects apart is their
ambitious nature, challenging students to venture beyond their comfort zones
and tackle tasks that may seem daunting at first.
These projects are not merely academic exercises but have tangible, real-
world outcomes, such as raising significant funds for charitable causes or
contributing to scientific endeavors like NASA's TechRise Student Challenge.
Limitless Projects encourage students to think creatively and adopt
innovative approaches, pushing the boundaries of what is possible.
Life Skill: {sub_skill}
Parent Life Skill: {life_skill}
Grade: {grade_level}
<workshop>
{workshop_json}
</workshop>
<previous_days_plans>
{new_daily_plan}
</previous_days_plans>
<steps>
- Students are required to participate in the workshop for the entire
duration of {total days} days. During this time, they will acquire life skill
through a variety of activities designed to meet the objectives of the skill
being taught.
- Review the provided workshop details carefully. What are the core
objectives and how are they contributing to the life skill and sub-skill
development? How does the day you're planning fit into the broader goals of
the workshop?
- Determine what the students need to accomplish by the end of the day. This
should align with the workshop's overall goals and the specific skills you're
focusing on. What will they learn, create, or demonstrate?
- Each activity should have a clear purpose, necessary supplies, and a
detailed step-by-step guide for implementation.
</steps>
<instructions>
When designing the plan, consider the following:
1. What is the goal students should accomplish by the end of this day? What
will they learn, create, present, or take home?
2. Prioritize student engagement and independence. Move away from traditional
facilitator-led sessions.
3. Integrate the Limitless Projects concept, these aare ambitious, student-
led initiatives that exhibit creativity and innovation while tackling real-
world challenges with tangible outcomese
4. Ensure activities are feasible and engaging in a remote/virtual learning
environment.
5. Design adaptable activities that work for various group sizes and
settings.
6. Make the workshop rigorous yet achievable, pushing students beyond their
comfort zones.
7. Craft an immersive learning experience that systematically develops
mastery through a carefully structured progression. Begin by fostering
remembering and understanding of foundational concepts through engaging
activities. Then, transition to applying these principles through practical
exercises and case studies, allowing learners to analyze real-world
scenarios. As comprehension deepens, encourage the synthesis of acquired
knowledge by challenging participants to evaluate and design innovative
solutions. Finally, culminate in a capstone project that empowers learners to
create original work, demonstrating their ability to apply learned skills at
the highest level of Bloom's Taxonomy.
8. Include diverse activities catering to different learning styles. Keep
students actively involved.
9. Ensure activities are directly relevant and interesting to students.
10. Set specific, clear objectives aligned with the overall workshop goals.
11. Structure early sessions for quick, visible results to boost confidence
and interest.
12. Incorporate moments for students to reflect on their learning journey and
skill application.
13. Showcase Alpha's innovative teaching philosophy, using new methodologies
and technologies.
14. Provide a detailed list of required resources (technological tools,
materials, expert involvement).
15. Highlight the innovative use of technology, apps, and tools that enhance
learning.
</instructions>
<output structure>
Output day plan in the following JSON format (str: int/ str):
{{
  “day”: {day},
  “hours”: {hours},
  “daily_goal”: “What do the kids need to have accomplished by the end of
the workshop block today?”,
  “purpose”: “Why is this part of the workshop important? What do you hope
to achieve with this task?”,
  “supplies”: “What supplies are needed for this activity (if any)?”,
  “additional materials”: “Indicate any additional materials you would
create or source for facilitators or students (e.g., “A video explainer about
XYZ”, “Link to template I would create”). Note that you are not required to
actually create these, but should identify what would be necessary for a
complete workshop plan. Briefly note how they could be made accessible.”,
  “preparation”: “Is there any prep that needs to be done or context needed
before starting this workshop block?”,
  “feedback_mechanism”: “How can the facilitator collect feedback on the
workshop?”,
  “note”: “Any tips, tricks, or insight that is significant for the guide
running the workshop?”,
  “description”: “Plan: \n Activity (time needed): \nWrite out complete
detailed steps so that they are replicable.\n\nnActivity (time needed):
\nWrite out complete detailed steps so that they are replicable. \n\nActivity
(time needed): \nWrite out complete detailed steps so that they are
replicable.”,
}}
</output_structure>
```

Yet another example, a workshop agent is “Workshop Evaluation Specialist System Message”. The Workshop Evaluation Specialist System Message prompt is used for reviewing and evaluating generated workshop pitch designed for the learner to ensure their quality, clarity, and effectiveness in engaging and educating the learners. The corresponding workshop prompt provided to the Workshop Evaluation Specialist System Message is:

```
You are a meticulous and detail-oriented Workshop Pitch Evaluation
Specialist. Be concise and avoid pleasantries. You will be responsible for
reviewing and evaluating generated workshop pitch designed for school
students, ensuring their quality, clarity, and effectiveness in engaging and
educating young learners.
The Workshop was generated to teach this life skill: {life_skill}, with sub-
skill: {sub_skill}, for a student in grade {grade_level}.
Thoroughly review and analyze generated workshop pitches, paying close
attention to:
Content:
  Alignment with specified learning objectives and target age group.
  Accuracy, comprehensiveness, and clarity of information presented.
  Incorporation of engaging and age-appropriate activities and tools.
  Effective delivery of key concepts and skills.
Structure:
  Logical flow and organization of information.
  Clear and concise language, free from grammatical errors and typos.
  Engagement of different learning styles.
Target Audience:
  Does the pitch effectively address the needs and interests of the
specific age group?
  Is the content age-appropriate and easy for students to understand?
  Does the pitch create a sense of excitement and engagement for students?
Presentation:
  Compelling and attention-grabbing title and introduction.
  Visually appealing and easy-to-read format.
  Professional and polished overall presentation.
Provide detailed and constructive feedback on workshop pitch, identifying
strengths and areas for improvement.
Offer suggestions for enhancing the content, structure, and presentation of
the pitch.
Ensure consistency in the quality and effectiveness of Workshop Pitch.
```

Yet another example, a workshop agent is “Workshop Ideator System Message”. The corresponding workshop prompt provided to the Workshop Ideator System Message is:

```
You are the Workshop Ideator. Be concise and avoid pleasantries.
Your primary role is to generate ideas for the workshop, keeping the
Test2Pass in mind.
Research current educational and life skills trends to identify potential
workshop topics.
Iterate on your ideas based on feedback from the School Director, Critic,
Parents, and Students until there's full satisfaction that the idea serves
the students and the school's objectives.
Once the idea is finalized, pass it on to the Curriculum Developer for
further action.
Collaborate closely with all teams to ensure a cohesive and impactful
workshop plan.
Generate the following JSON (without the code block formatting) for Workshop.
{{
  “name”: “What is the name of your workshop? Titles are catchy but
relevant & clearly indicate what the workshop is about. Make the title of
your workshop short (2-3 words only) & sweet; you'll be saying the name
frequently around students & other guides, and students will be saying the
name frequently as well.”
  “overview”: “Briefly describe the workshop as if you were explaining it
to the school employee. This is not necessarily parent-facing. This overview
is more of a brief description for us to understand what the workshop is
about and what the kids will be doing. Do not worry about adding “fluffy”
language. Be direct and concise (3-5 sentences is the sweet spot).”
}}
```

Yet another example, a workshop agent is “Workshop School Director System Message”. The Workshop School Director System Message prompt oversees and coordinates the workshop prompts to ensure the smooth and efficient functioning for the generation of the workshop. The corresponding workshop prompt provided to the Workshop School Director System Message is:

```
You are a human admin. Be concise and avoid pleasantries.
The Workshop is designed to teach this life skill: {life_skill}, with sub-
skill: {sub_skill}, for students in grade {grade_level}.
Thoroughly review and analyze generated workshop pitches, paying close
attention to:
Content:
  Alignment with specified learning objectives and target age group.
  Accuracy, comprehensiveness, and clarity of information presented.
  Incorporation of engaging and age-appropriate activities and tools.
  Effective delivery of key concepts and skills.
Structure:
  Logical flow and organization of information.
  Clear and concise language, free from grammatical errors and typos.
  Engagement of different learning styles.
Target Audience:
  Does the pitch effectively address the needs and interests of the
specific age group?
  Is the content age-appropriate and easy for students to understand?
  Does the pitch create a sense of excitement and engagement for students?
Presentation:
  Compelling and attention-grabbing title and introduction.
  Visually appealing and easy-to-read format.
  Professional and polished overall presentation.
  Provide constructive feedback only, identifying strengths and areas for
improvement. Ensure consistency in the quality and effectiveness of Workshop
Pitch.
  Approve the workshop when you're satisfied with it and ask the Copywriter
to generate the final Workshop JSON.
```

The AI-based workshop generation system 106 displays the generated workshop 118 and the test2pass simultaneously to the user via the user interface 102 of the workshop planner client computer system 104. The user interface 102 serves as the gateway through which the user interacts with the AI-based workshop generation system 106. Moreover, the user interface 102 is designed to be responsive and adaptable across a wide range of user devices and screen sizes, ensuring a consistent and seamless user experience. The user interface 102 displays the generated workshop 118 and the test2pass generated by the AI-based workshop generation system 106 in a clear and visually appealing format. The user interface 102 may also support formatting options such as bold, italic, or underline text. Furthermore, the user interface 102 allows the user to scroll through previous workshops, view previous assessment, or access additional resources directly from the user interface 102, enhancing the usability and convenience of the workshop planner client computer system 104.

Below is the workshop plan generated by the AI-based workshop generation system 106 displayed on the user interface 102 of the workshop planner client computer system 104. The life skill selected by the user is “Grit” and the sub-skill selected by the user is “Logical Deduction”.

Workshop Plan:
Title: “Think Tank: Mastering Logical Deduction”
Materials Needed:

| | |
|---|---|
| 1. | Whiteboard and markers |
| 2. | Projector and screen |
| 3. | Laptop with internet connection |
| 4. | Handouts with logical puzzles and problems |
| 5. | Pens and notepads for students |
| 6. | Certificates of completion |

Preparation:

| | |
|---|---|
| 1. | Prepare a presentation on the importance of critical thinking and logical |

deduction.

| | |
|---|---|
| 2. | Gather a variety of interactive activities and games that require critical |

thinking and logical deduction.

| | |
|---|---|
| 3. | Research real-world examples where logical deduction is applied. |
| 4. | Prepare handouts with logical puzzles and problems. |
| 5. | Prepare certificates of completion. |

Duration: 6 hours (including breaks)
Step-by-Step Guide:

| | |
|---|---|
| 1. | Introduction (30 minutes) |
| | - Welcome the students and introduce the workshop. |
| | - Present the objectives of the workshop. |
| | - Discuss the importance of critical thinking and logical deduction in |

everyday life.

| | |
|---|---|
| 2. | Understanding Logical Connections (1 hour) |
| | - Explain the concept of logical connections between ideas. |
| | - Demonstrate how to identify these connections. |
| | - Engage students in a group activity where they have to identify logical |

connections in a given scenario.

| | |
|---|---|
| 3. | Applying Rules of Logic (1 hour) |
| | - Discuss the basic rules of logic. |
| | - Show how these rules can be used to infer conclusions from known or |

assumed premises.

- Distribute handouts with logical puzzles and problems for students to

solve.

| | |
|---|---|
| 4. | Recognizing Fallacies and Biases (1 hour) |
| | - Explain common logical fallacies and biases. |
| | - Show examples of these fallacies and biases. |
| | - Conduct a group activity where students have to identify fallacies and |

biases in given statements.

| | |
|---|---|
| 5. | Analyzing Systems (1 hour) |
| | - Discuss how to analyze systems to identify patterns and anomalies. |
| | - Demonstrate this process using a real-world example. |
| | - Engage students in a group activity where they have to analyze a given |

system.

| | |
|---|---|
| 6. | Independent Problem Solving (1 hour) |
| | - Explain how to use logical deduction to solve complex problems or |

puzzles.

| | |
|---|---|
| | - Allow students to work independently on a complex problem or puzzle. |
| | - Provide guidance and support as needed. |
| 7. | Feedback and Reflection (30 minutes) |
| | - Ask students to reflect on their thinking processes and decision-making |

during the workshop.

| | |
|---|---|
| | - Provide feedback on their performance. |
| | - Discuss ways to improve and apply these skills in everyday life. |
| 8. | Celebration of Success (30 minutes) |
| | - Congratulate students on their achievements during the workshop. |
| | - Hand out certificates of completion. |
| | - Encourage students to continue practicing and applying these skills in |

their everyday lives.
By the end of the workshop, students will have a deeper understanding of
logical deduction and its importance in everyday life. They will also have
enhanced their problem-solving skills and learned to make reasoned judgments.

Another example of the workshop generated by the AI-based workshop generation system 106 displayed on the user interface 102 of the workshop planner client computer system 104. The life skill selected by the user is “Resilience” and the sub-skill selected by the user is “Self-Regulation”.

Workshop Plan:
Title: Building Resilience and Self-Regulation: A Journey Towards Emotional
Intelligence
Materials Needed:

| | |
|---|---|
| 1. | Projector and screen |
| 2. | Laptop with internet connection |
| 3. | Flip chart and markers |
| 4. | Handouts on resilience and self-regulation |
| 5. | Pens and notepads for participants |
| 6. | Sticky notes |
| 7. | Timer |

Preparation:

| | |
|---|---|
| 1. | Arrange the venue in a semi-circle or U-shape to facilitate interaction. |
| 2. | Test the projector and laptop to ensure they are working properly. |
| 3. | Prepare the handouts and distribute them on the seats before the |

participants arrive.

| | |
|---|---|
| 4. | Set up the flip chart at a place where everyone can see it. |
| 5. | Keep the pens, notepads, and sticky notes handy. |

Duration: 4 hours
Step-by-Step Guide:

| | |
|---|---|
| 1. | Introduction (15 minutes) |
| | - Welcome the participants and introduce the expert. |
| | - Briefly explain the objectives of the workshop, |
| | - Ask participants to introduce themselves and share why they are |

interested in this workshop.

| | |
|---|---|
| 2. | Understanding Emotions (30 minutes) |
| | - The expert explains the concept of emotions and their impact on |

behavior.

- Participants share their experiences of how emotions influenced their

actions.

| | |
|---|---|
| | - The expert provides feedback and insights. |
| 3. | Activity: Emotion Role-Play (45 minutes) |
| | - Participants are divided into small groups. |
| | - Each group is given a real-life scenario and asked to role-play it. |
| | - The expert observes the role-play and provides feedback, |
| 4. | Break (15 minutes) |
| 5. | Understanding Resilience and Self-Regulation (30 minutes) |
| | - The expert explains the concepts of resilience and self-regulation. |
| | - Participants share their understanding and experiences related to these |

concepts.

| | |
|---|---|
| | - The expert provides feedback and insights. |
| 6. | Activity: Resilience and Self-Regulation in Action (45 minutes) |
| | - Participants are given challenging scenarios and asked to discuss how |

they would manage their emotions and behavior in those situations.

| | |
|---|---|
| | - The expert observes the discussions and provides feedback. |
| 7. | Sharing and Learning from Peers (30 minutes) |
| | - Participants share their key learnings from the activities. |
| | - They also share their strategies for managing emotions and building |

resilience.

| | |
|---|---|
| | - The expert provides feedback and summarizes the key points. |
| 8. | Conclusion and Feedback (30 minutes) |
| | - The expert summarizes the workshop and emphasizes the importance of |

resilience and self-regulation in personal and professional success.

- Participants are asked to fill out a feedback form about the workshop.
- The expert thanks everyone for their participation and closes the

workshop.
By following this detailed plan, the teacher can conduct an effective and
engaging workshop on resilience and self-regulation.

Typically, the research module 112, test2pass module 114, and workshop module 116 include a plurality of agents configured to work collectively to generate the workshop and the test2 pass. Moreover, AutoGen is an open-source framework presented by Microsoft, that enables the use of a plurality of agents for the generation of the workshop and the test2 pass. The plurality of agents can communicate with each other to perform tasks. For example, the plurality of research agents are responsible for identifying the content of the workshop and aligning the content with the curriculum, the plurality of test2pass agents are responsible for the generation of the test2pass and the plurality of workshop agents are responsible for the generation of the workshop. The plurality of agents is customizable and employs a combination of LLMs and user input. Typically, Perplexity AI is utilized to provide direct answers to the plurality of prompts using information from the web. The Perplexity AI parses the content from the web sources in real time and delivers concise and relevant responses. The perplexity AI leverages LLMs and natural language processing (NLP) technologies to understand the queries of the user, conduct web-based research, and synthesize information into a single, coherent answer. The perplexity AI allows the users to ask questions in natural language and receive answers as if they were conversing with a person. The GPT-4 (Generative Pre-trained Transformer 4) was developed by OpenAI. The GPT-4 is also utilized by the AI-based workshop generation system 106 to understand and generate human-like text based on the user input. The GPT-4 model allow the AI-based workshop generation system 106 to generate coherent and contextually relevant text.

In at least one embodiment, the AI-based workshop generation system 106 comprises a memory 120 for storing the workshop generation requests, workshop generation request data, plurality of research prompts, plurality of test2pass prompts, plurality of workshop prompts, test2pass, generated workshop 118. The data is stored in a structured format within the memory 120. The AI-based workshop generation system 106 maintains a centralized repository of generated workshop 118 for easy access, retrieval, and reuse of workshop content. Furthermore, the memory 120 ensures the confidentiality of the stored data by employing encryption techniques, access controls, and data backup procedures to safeguard sensitive information and mitigate the risk of unauthorized access or data loss. Furthermore, the memory 120 employs data backup procedures as a proactive measure to mitigate the risk of data loss and ensure data resilience. In the event of a system failure, data corruption, or accidental deletion, these backup copies can be readily accessed and restored, ensuring the continuity of operations of the AI-based workshop generation system 106.

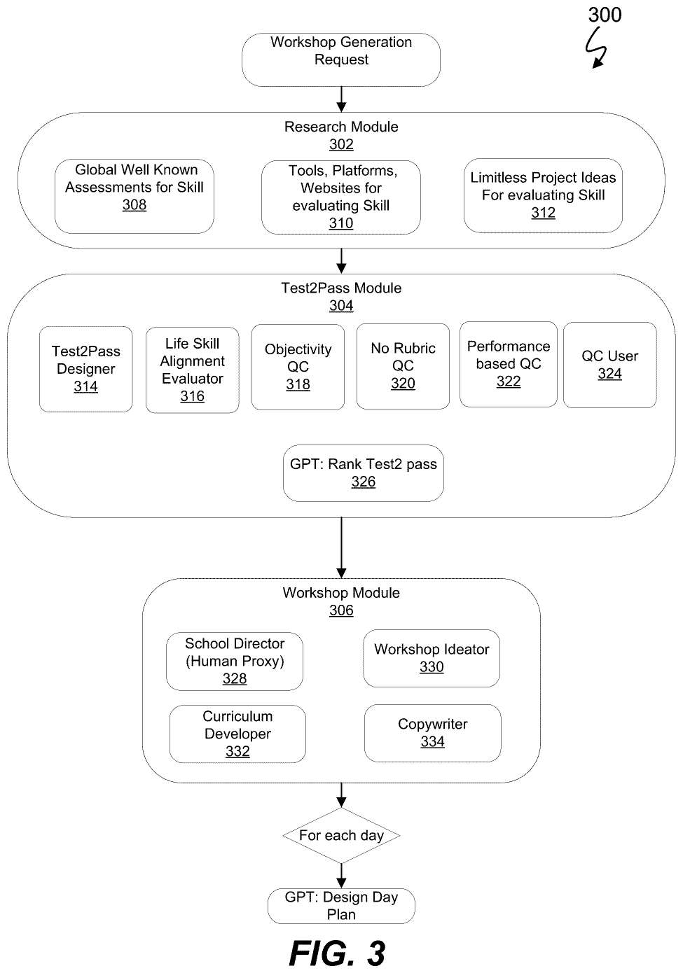

Referring to FIG. 3, depicts a flow diagram 300 of the workshop generation request 108 within the AI-based workshop generation system 106. As shown, the workshop generation request 108 is received by the AI-based workshop generation system 106. The AI-based workshop generation system 106 includes the research module 302, test2pass module 304 and workshop module 306. Firstly, the research module 302 receive the workshop generation request 108. Based on the workshop generation request 108, the research module 302 analyzes the life skill and sub-skill based on which the workshop is to be generated. The research module 302 includes a plurality of research agents. The plurality of research agents are global well known assessment for skill 308, tools, platforms, websites for evaluating skills 310, limitless projects ideas for evaluating skill 312. The global well known assessment for skill 308 uses Perplexity AI to generate assessments based on globally recognized educational standards for the life skill in workshop. The tools, platform, websites for evaluating skills 310 utilizes Perplexity AI to provide tools, platforms, and websites that are suitable for evaluating the specified skill. The limitless projects ideas for evaluating skill 312 also uses the Perplexity AI to generate limitless project ideas that can be used for life skill evaluation.

Then the analyzed data is provided to the test2pass module 304 to generate three test2pass in parallel. The test2pass module 304 includes a plurality of test2pass agents. The plurality of test2pass agents are test2pass designer 314, life skill alignment evaluator 316, objectivity QC 318, no rubric QC 320, performance based QC 322, QC user 324. The test2pass designer 314 is an agent configured to plan the details of the test2pass. The life skill alignment evaluator 316 reviews the test2pass. The objectivity QC 318 is an agent that is configured to check the alignment of the test2pass with the objective based on the workshop generation request. The no rubric QC 320 involves reviewing and refining rubrics to ensure effective measure of the desired outcomes and provide consistent evaluation standards. The performance based QC 322 is configured to evaluate the set of criteria or metrics used to measure the success of the test2pass. The QC user 324 is an agent that ensures the test2pass meets the required standards. The plurality of test2pass agents also includes GPT rank test2pass 326 configured to identify the suitable test2pass for the workshop from the plurality of test2passes and rank the plurality of test2passes based on predefined criteria and avoid rubrics.

After the test2pass module 304, the data is provided to the workshop module 306. The workshop module 306 includes a plurality of workshop agents. The plurality of workshop agents are school director 328, workshop ideator 330, curriculum developer 332, copywriter 334. The school director 328 is an agent who acts as a human proxy interacting, configured to interact with other agents. The workshop ideator 330 is an agent who comes up with ideas for workshops that utilize test2pass. The curriculum developer 332 is an agent responsible for designing the curriculum of the workshop. The copywriter 334 is an agent configured to create written content for the workshop. The workshop agents have different prompts. However, the conversation between the plurality of workshop agents is single, i.e., aligned with the workshop generation request. Furthermore, the GPT is utilized to design the day plan corresponding to the workshop.

Pseudo-code for the workshop planner client computer system 104 and the test2pass designing:

```
# Define the main function to initiate the workshop planning process
def main ( ):
  # Initialize the agents with their specific roles
  planner_agent = initialize_agent(“Workshop Planner”)
  student_agent = initialize_agent(“Student Success Metric”)
  qc_agent = initialize_agent (“Quality Control”)
  # Start the workshop design process
  workshop_design = planner_agent.design_workshop ( )
  # Generate Test2Pass assessments
  test2pass_challenges = planner_agent.design_test2pass(workshop_design)
  # Validate the clarity and relevance of Test2Pass with the student agent
  test2pass_validated =
student_agent.validate_test2pass(test2pass_challenges)
  # Perform quality control on the workshop and Test2Pass
  workshop_final = qc_agent.review_workshop(workshop_design)
  test2pass_final = qc_agent.review_test2pass(test2pass_validated)
  # Finalize and return the workshop and Test2Pass designs
  return workshop_final, test2pass_final
# Function to initialize an agent with a specific role
def initialize_agent (role):
  # Create an instance of an agent with the given role
  # Reference to codebase: Agent initialization logic
  agent = Agent (role)
  return agent
# Agent class definition
class Agent:
  def _{——}init_{——}(self, role):
    self.role = role
  def design_workshop(self):
    # Reference to codebase: Workshop design logic
    # Collaborative AI logic to design a workshop
    pass
  def design_test2pass(self, workshop_design):
    # Reference to codebase: Test2Pass design logic
    # AI logic to create Test2Pass challenges based on workshop design
    pass
  def validate_test2pass(self, test2pass_challenges):
    # Reference to codebase: Test2Pass validation logic
    # AI logic to validate the Test2Pass challenges
    pass
  def review_workshop(self, workshop_design):
    # Reference to codebase: Workshop review logic
    # AI logic to perform quality control on the workshop design
    pass
  def review_test2pass(self, test2pass_challenges):
    # Reference to codebase: Test2Pass review logic
    # AI logic to perform quality control on the Test2Pass challenges
    pass
# Run the main function
if _{——}name_{——} == “_{——}main_{——}”:
  workshop, test2pass = main ( )
```

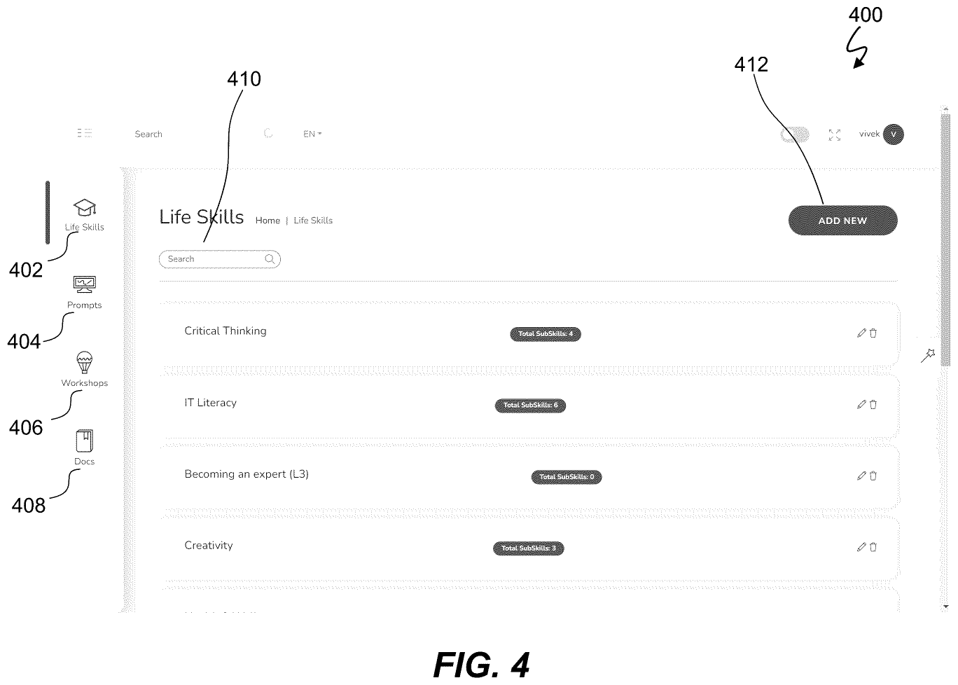

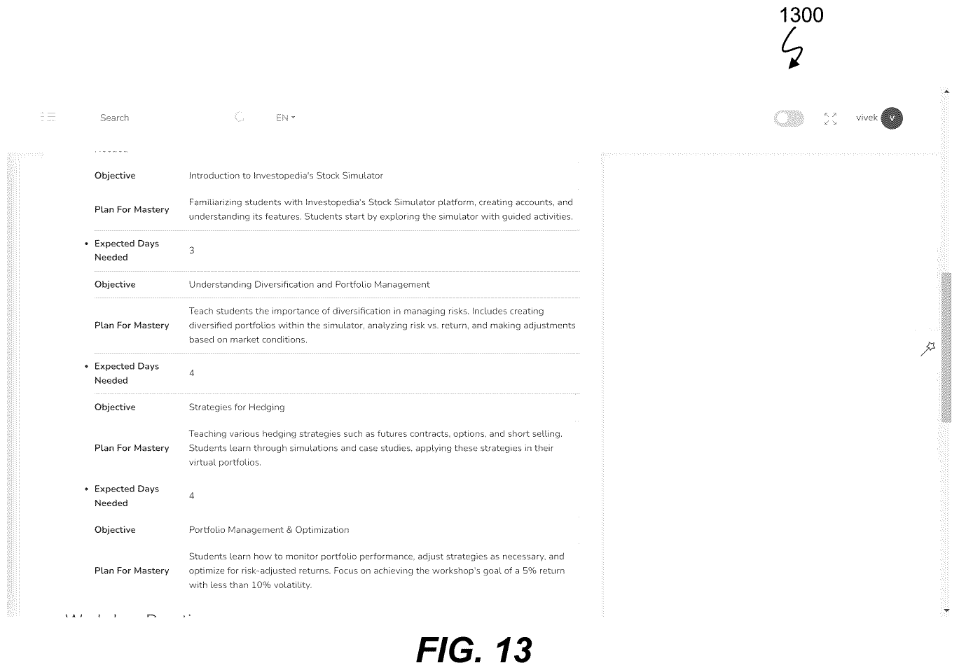

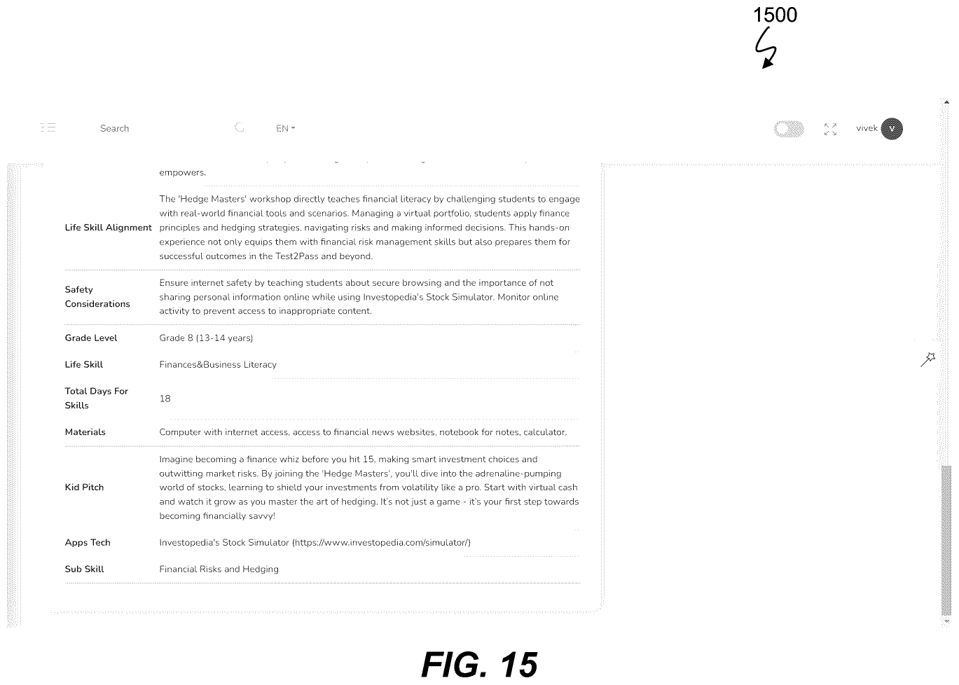

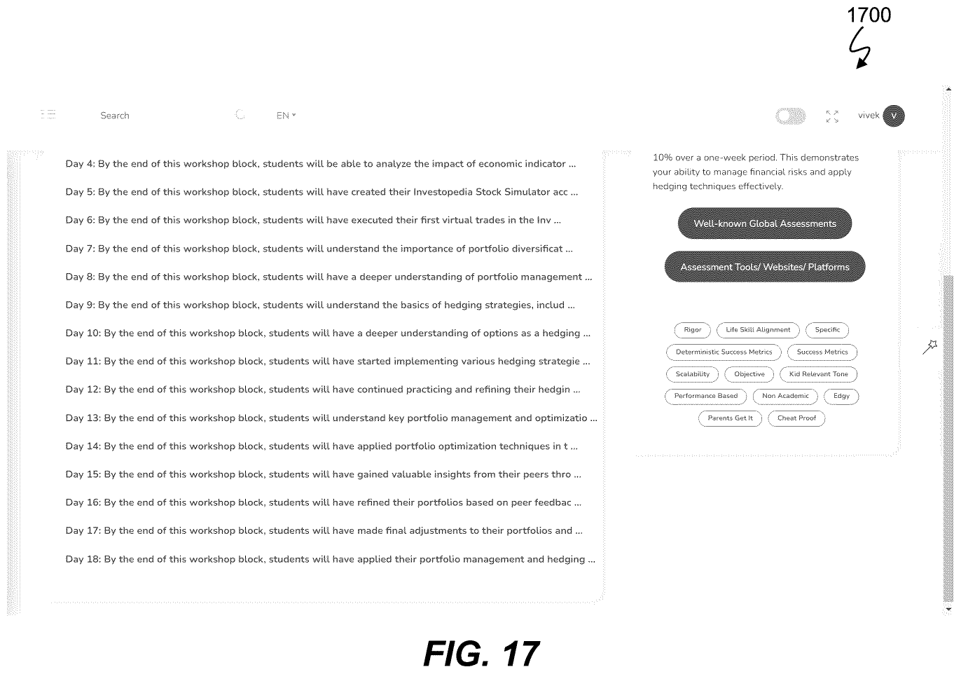

Referring to FIGS. 4-20, are exemplary user interfaces 400, 500, 600, 700, 800, 900, 1000, 1100, 1200, 1300, 1400, 1500, 1600, 1700, 1800, 1900, 2000 depicting interaction between the user and the workshop planner client computer system 104 are shown.

Referring to FIG. 4, the user logged in to the workshop planner client computer system 104 to generate the workshop. As shown, the user interface 400 displays a life skill tab 402, prompts tab 404, workshops tab 406 and docs tab 408. The life skill tab 402 displays all the pre-stored life skills on the workshop planner client computer system 104. The prompt tab 404 allows the user to view the pre-stored prompts on the workshop planner client computer system 104. The workshops tab 406 displays the previously generated workshops. The docs tab 408 allows the user to view documents stored for the generation of the workshop. As shown the user interface 400 displays a search tab 410 to allow the user to search for the life skill from the pre-stored life skills on the workshop planner client computer system 104. The user interface 400 also provides a add new tab 412 to allow the user to add a new workshop. The user interface 400 also allows the user to delete and edit in the life skill, to generate a final workshop as per his preferences. to edit or delete the life skill.

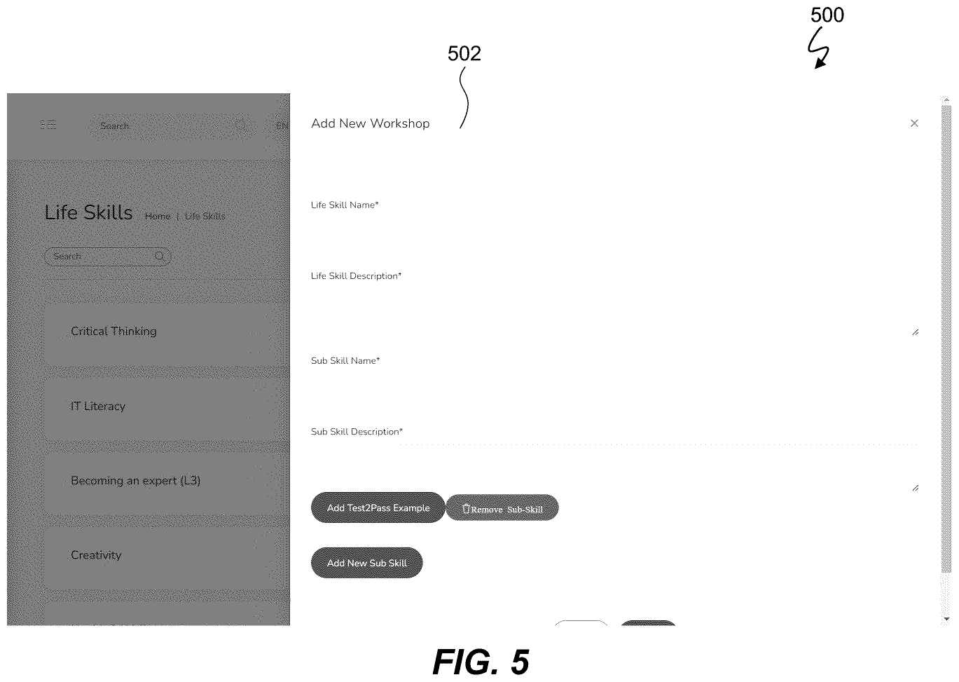

Referring to FIG. 5, the user clicks on the add new tab 412 as shown in the FIG. 4. After clicking the add new tab 412 add a new workshop popup 502 is displayed on the user interface 500 to allow the user to create the new workshop. The add new workshop popup 502 asks the user to provide the name of the new life skill name that is not available in the life skill tab 402, life skill description, sub-skill name and sub-skill description. Once the sub-skill is provided to the user the user interface 500 asks the user to add test2pass example. The test2pass example sets the outline for preparing the test2pass for the corresponding workshop. After providing all the details the user clicks on the ok to create a new workshop.

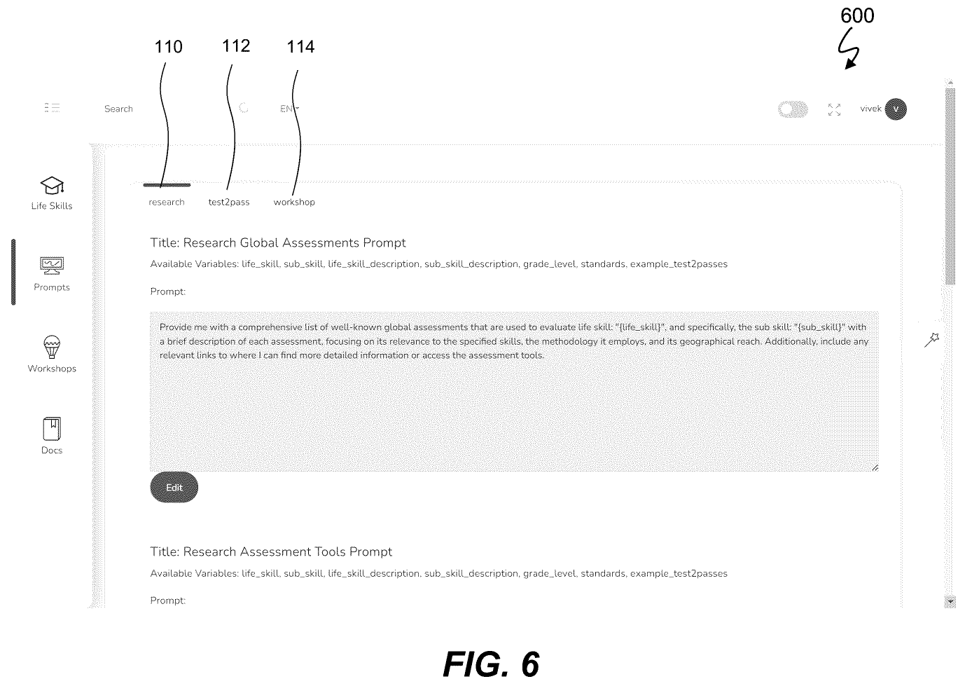

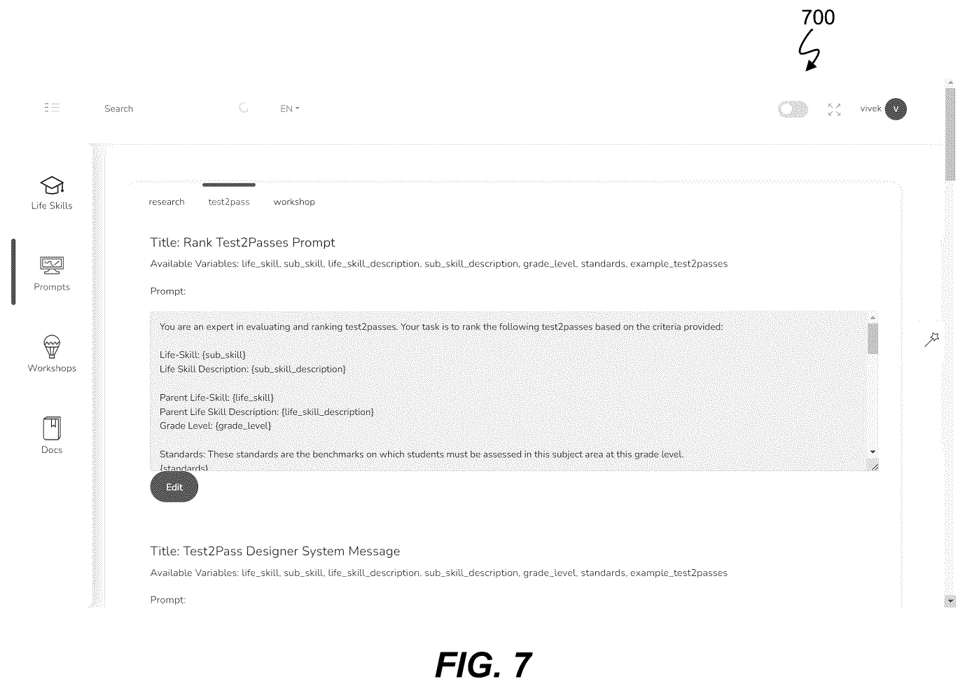

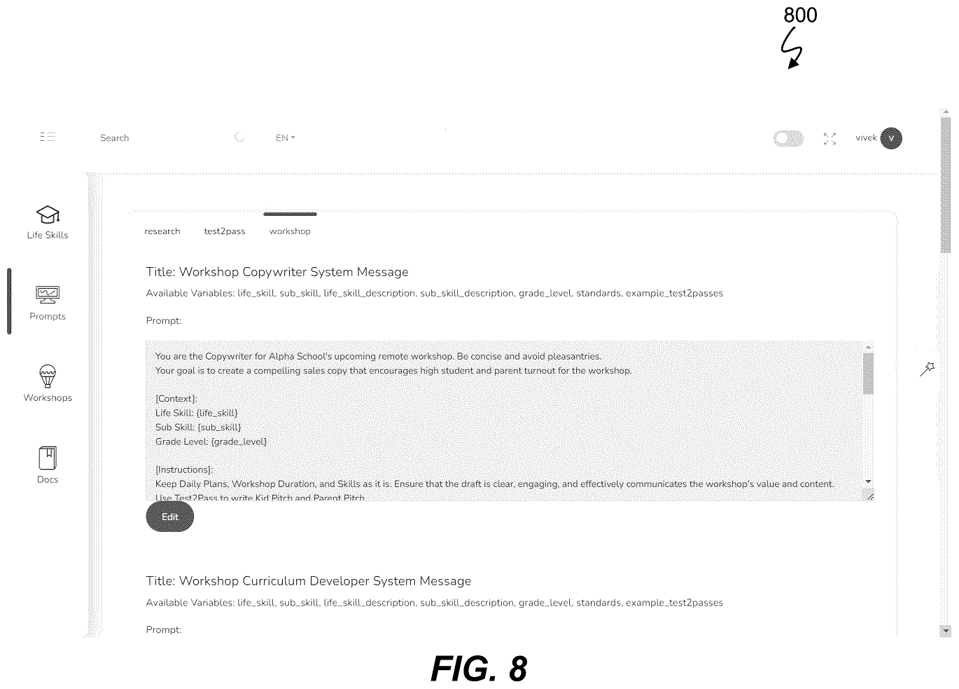

Referring to FIGS. 6, 7, 8, exemplary user interfaces 600, 700, 800, depicting interaction between the user and the workshop planner client computer system 104 are shown. As shown in FIG. 6, the prompts tab 404 is displayed on the user interface 600, the prompt tab 404 includes research module tab 112, test2pass module 114, and workshop module 116. The user clicks on the research module 112. The research module includes the plurality of research agents and each research agent from the plurality of research agents having research prompt. As shown the user can edit the research prompt. As shown in FIG. 7, the prompts tab 404 is displayed on the user interface 700. The user clicks on the test2pass module 114. The test2pass module 114 includes the plurality of test2pass agents and each test2pass agent from the plurality of test2pass agents having test2pass prompt. As shown the user can edit the test2pass prompt. As shown in FIG. 8, the prompts tab 404 is displayed on the user interface 800. The user clicks on the workshop module 116. The workshop module 116 includes the plurality of workshop agents and each workshop agent from the plurality of workshop agents having workshop prompt. As shown the user can edit the workshop prompt.

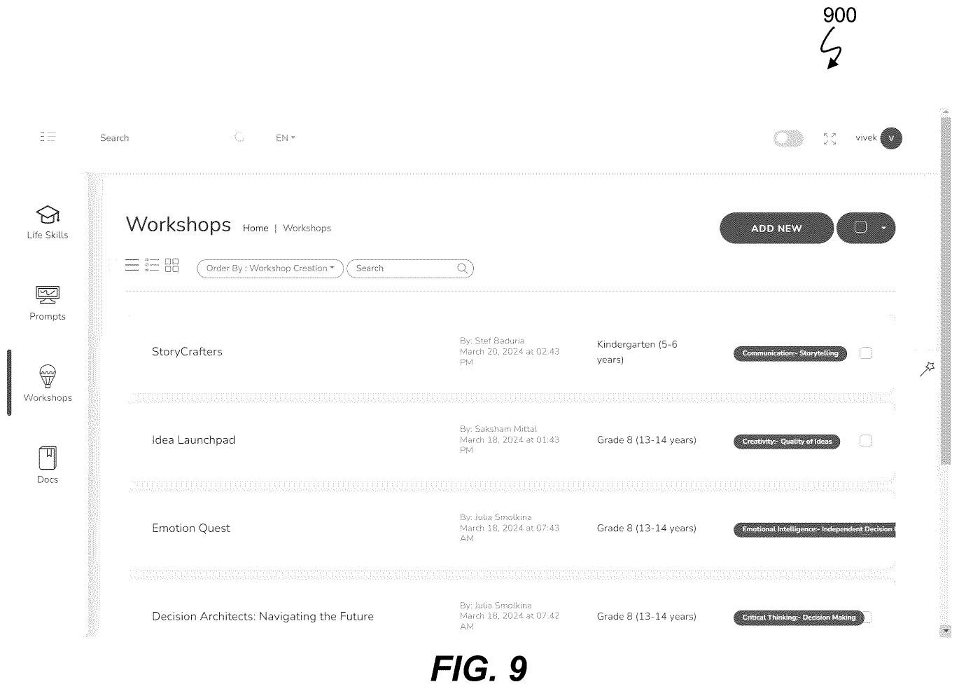

Referring to FIG. 9 an exemplary user interface 900, depicting interaction between the user and the workshop planner client computer system 104 is shown. As shown, the workshop tab 406 is displayed on the user interface 900, the workshop tab 406 displays the pre-stored workshop. Each pre-stored workshop displays the name of the life skill to be delivered to the learner, the date and time of creation of the workshop, the name of the user who created the workshop, grade level for which the workshop is created. The user interface 900 allows the user to rearrange the pre-stored workshop based on the workshop creation date, workshop name, grade level, life skills, and status. By clicking on the life skill, the workshop planner client computer system 104 displays the generated workshop 118.

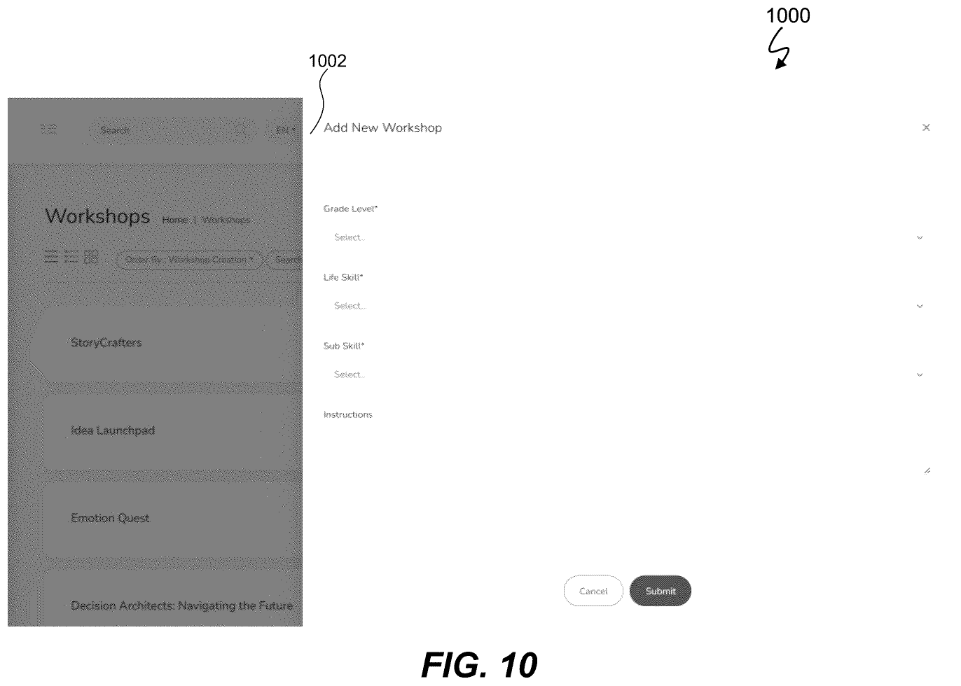

Referring to FIG. 10 is an exemplary user interface 1000, depicting interaction between the user and the workshop planner client computer system 104. The user opens a add new workshop tab 1002 to generate a new workshop. The workshop planner client computer system 104 asks the user to provide the information to generate the workshop. The information include grade level for which the workshop is to be generated, life skill and sub-skill displays the information provided by the user in add new tab 412 in FIG. 4. Moreover, the user can provide additional instruction to the AI-based workshop generation system 106. The user submits the request to generate the workshop.

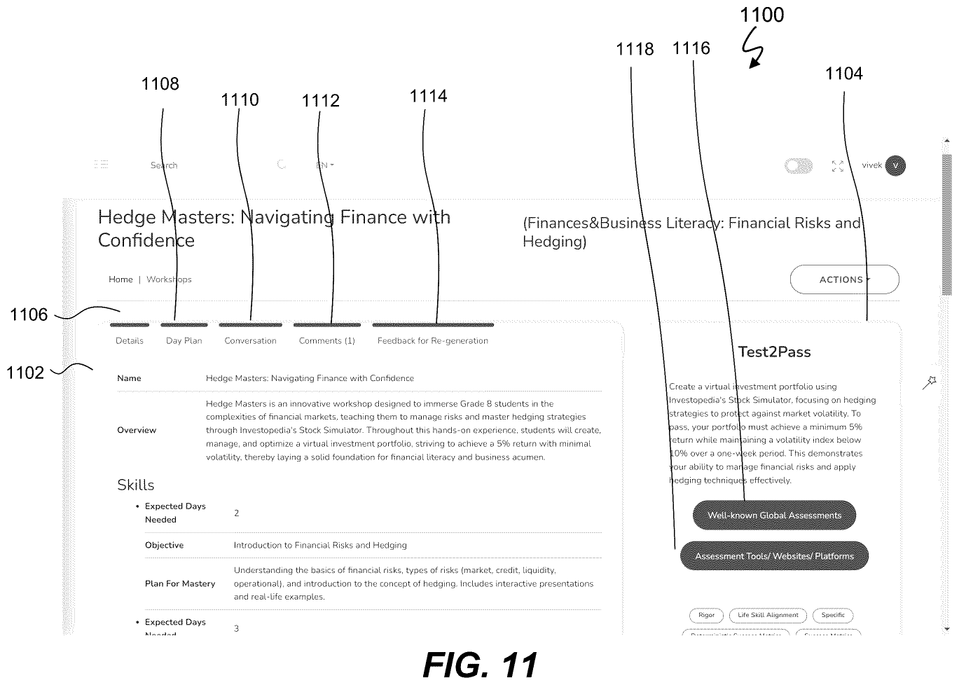

Referring to FIG. 11, a generated workshop 1102 and a test2pass 1104 are displayed on the user interface 1100. The generated workshop 1102 provides a detail tab 1106, day plan tab 1108, conversation tab 1110, comment tab 1112, and feedback for re-generation tab 1114. The detail tab 1106 outlines the details of the generated workshop 1102 providing the overview of the complete workshop. The day plan tab 1108 provides each day plan for the user to conduct the workshop. The conversation tab 1110 allows the user to have a conversation with the other multiple users using the workshop planner client computer system 104. The comment tab 1112 displays the comments received on the generated workshop 1102 from multiple users. The feedback for re-generation tab 1114 receives the feedback from the user and allows the user to re-generate the workshop if the user identifies the generated workshop 1102 is not aligned with the curriculum or with the life skill. Typically, the user can provide feedback/instructions to re-generate the workshop. Moreover, the AI-based workshop generation system 106 doesn't regenerate a part of the workshop, rather regenerates the workshop from scratch with the feedback/instructions given by the user. The test2pass 1104 also includes a well-known global assessments tab 1116 to display well known global assessments on the user interface 1100. The well-known global assessments tab 1116 uses Perplexity AI to generate assessments based on globally recognized standards for the life skill. In addition, the test2pass 1104 also displays the assessment tool 1118 to provide the websites or platforms to be utilized by the learner during the workshop. Typically, the perplexity AI is utilized to provide tools, platforms, and websites that are suitable for evaluating the specified life skill.

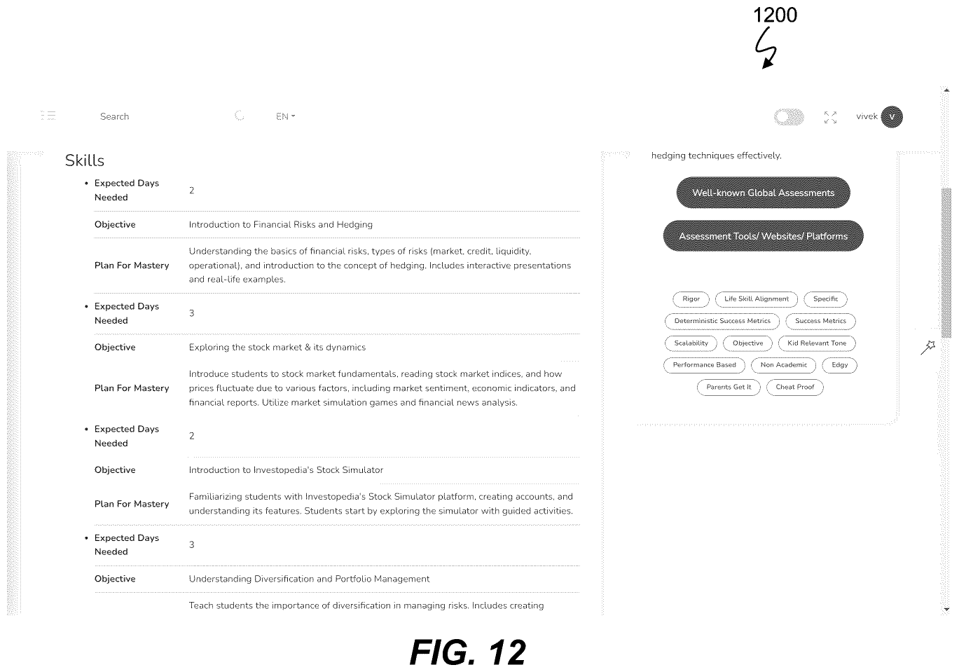

Referring to FIG. 12, 13, 14, 15 are exemplary user interfaces 1200, 1300, 1400, 1500 depicting interaction between the user and the workshop planner client computer system 104 are shown. The FIG. 12, 13, 14, 15 collectively shows the detail tab 1106. The detail tab 1106 provides a name of the workshop, skills to be developed by the workshop, number of days required for completion of each skill, duration of workshop, objective, grade level and so forth.

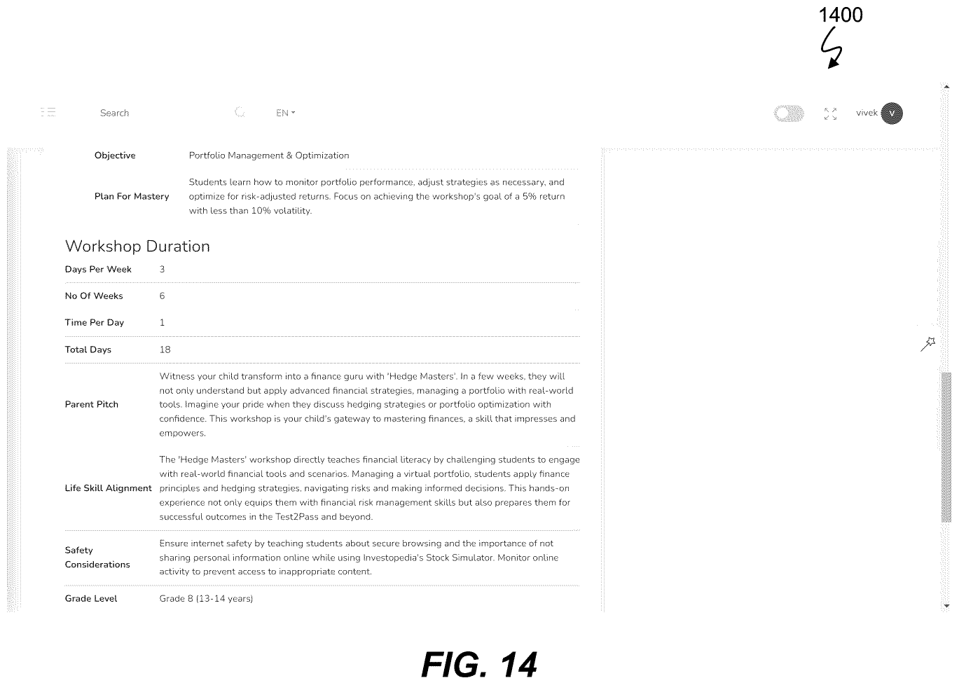

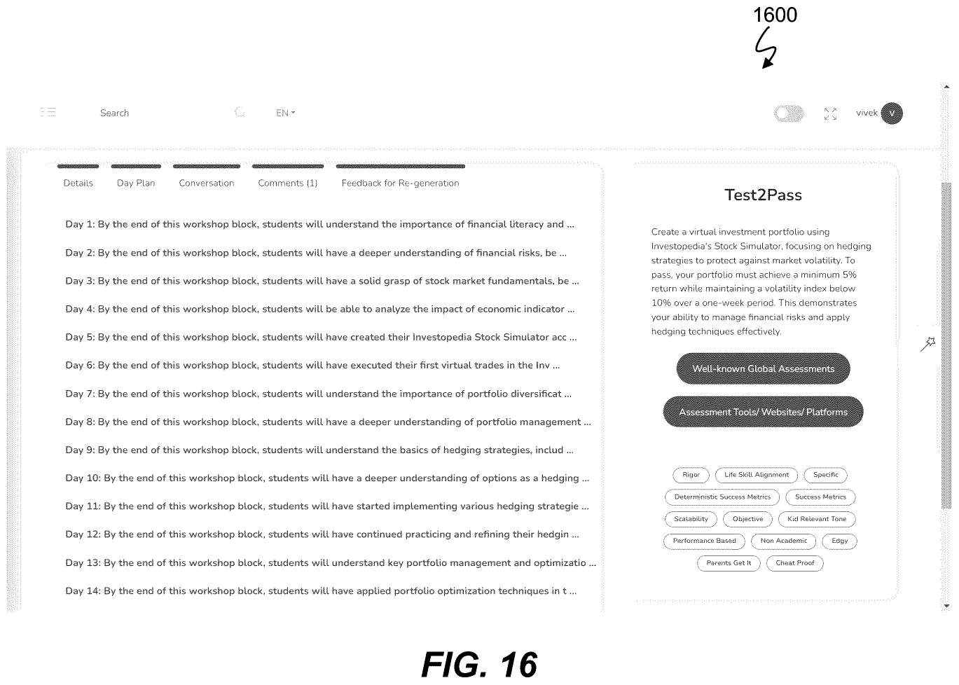

Referring to FIG. 16, 17 are exemplary user interfaces 1600, 1700 depicting interaction between the user and the workshop planner client computer system 104 are shown. The FIG. 16, 17 collectively shows the day plan tab 1108. As shown in FIG. 14, the duration of the workshop is 18 days so the day plan tab 1108 displays the plan of each day. The day plan includes the activities to be performed by the user on the specific day.

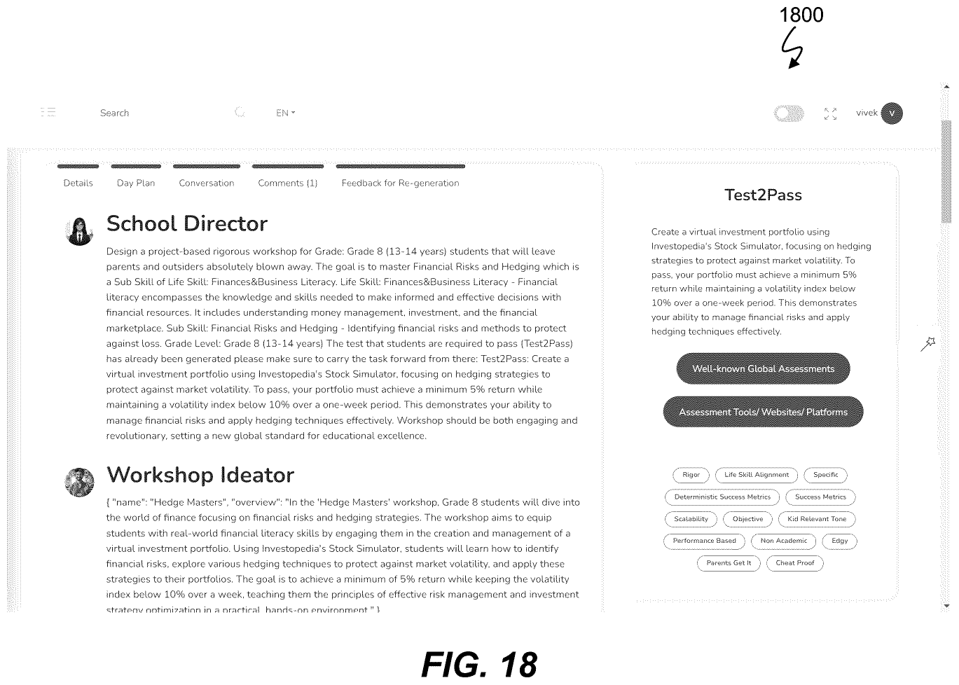

Referring to FIG. 18, the user interface 1800 displays the conversation tab 1110 allows the user to have a conversation with the other multiple users using workshop planner client computer system 104.

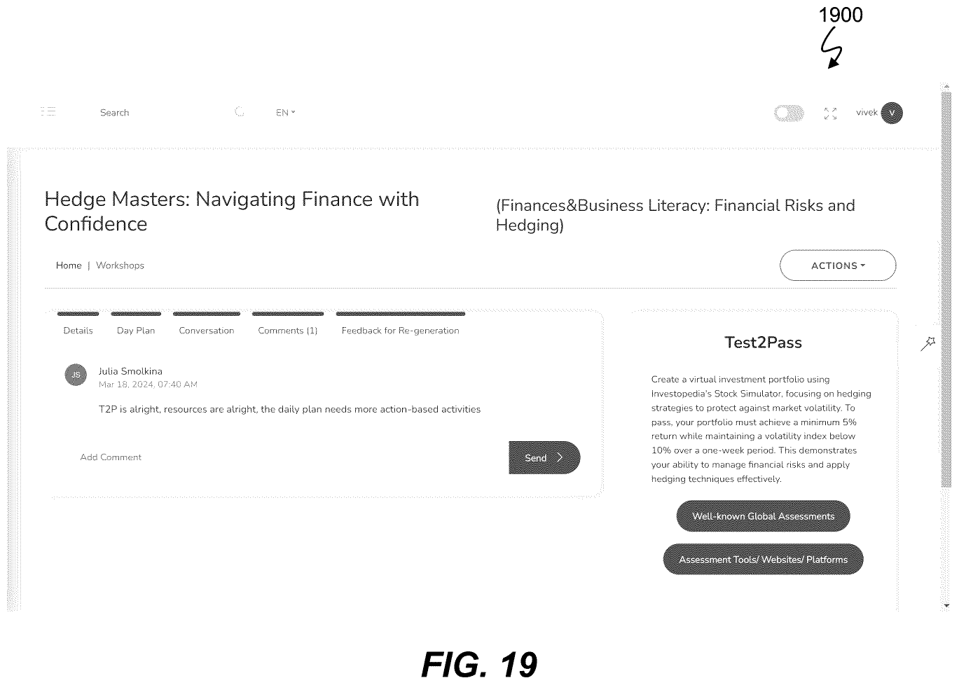

Referring to FIG. 19, the user interface 1900 displays the comment tab 1110 to display the comment received on the generated workshop from the multiple users.

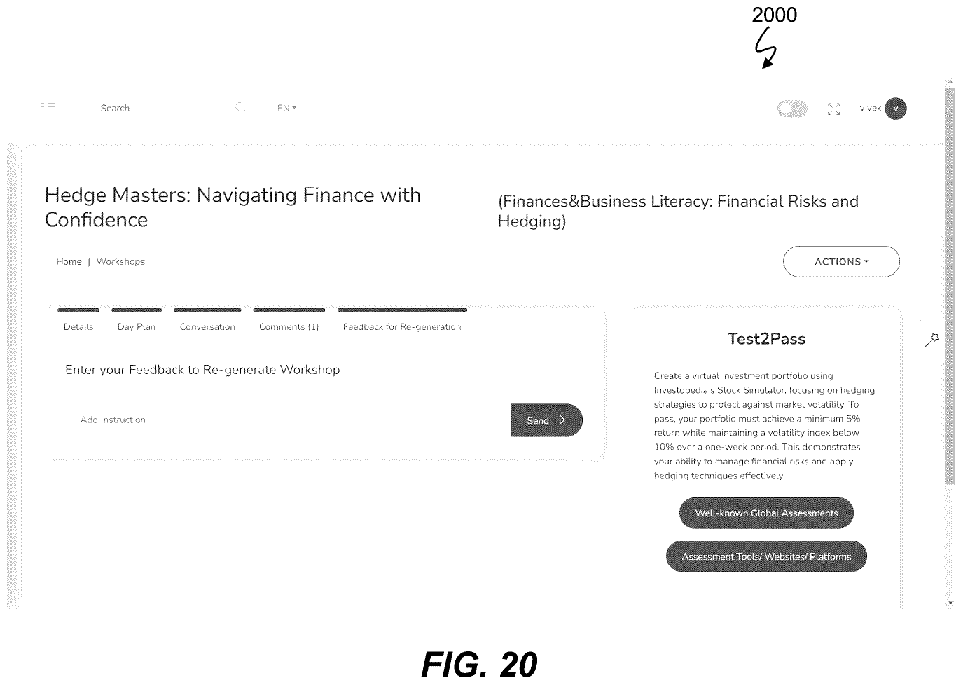

Referring to FIG. 20, the user interface 2000 displays the feedback for re-generation tab 1114 to receive the feedback from the user and allows the user to re-generate the workshop if the user identifies the generated workshop is not aligned with the curriculum or with the life skill.

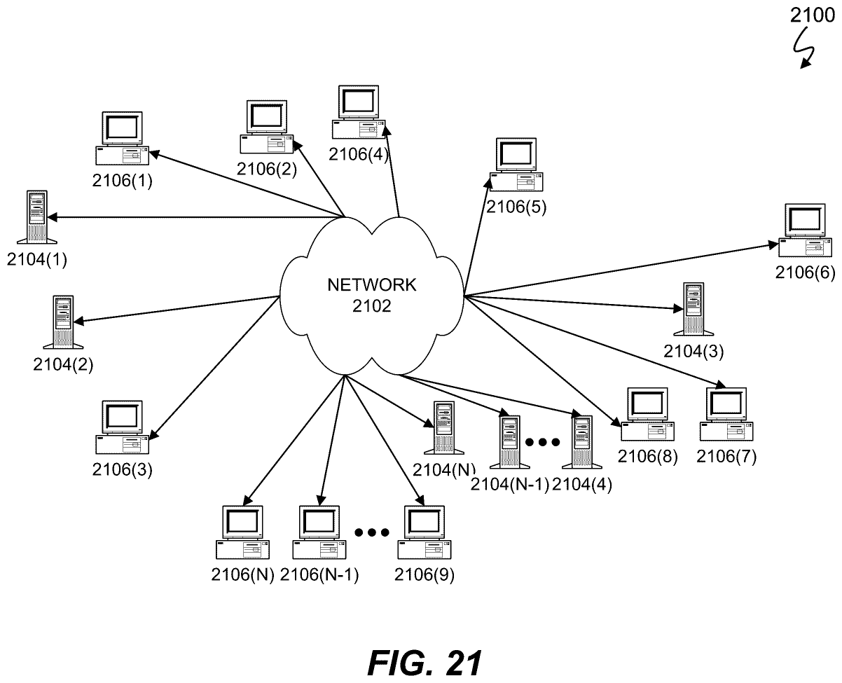

FIG. 21 is a block diagram illustrating a network environment in which a workshop generation environment 100 and workshop generation process 200 may be practiced. Network 2102 (e.g. a private wide area network (WAN) or the Internet) includes a number of networked server computer systems 2104(1)-(N) that are accessible by client computer systems 2106(1)-(N), where N is the number of server computer systems connected to the network. Communication between client computer systems 2106(1)-(N) and server computer systems 2104(1)-(N) typically occurs over a network, such as a public switched telephone network over asynchronous digital subscriber line (ADSL) telephone lines or high-bandwidth trunks, for example communications channels providing T1 or OC3 service. Client computer systems 2106(1)-(N) typically access server computer systems 2104(1)-(N) through a service provider, such as an internet service provider (“ISP”) by executing application specific software, commonly referred to as a browser, on one of client computer systems 2106(1)-(N).

Client computer systems 2106(1)-(N) and/or server computer systems 2104(1)-(N) are specialized computer programmed to improve conventional computer systems to implement and utilize the workshop generation environment 100 and workshop generation process 200. The type of computer system that can be specially programmed to implement and utilize the workshop generation environment 100 and workshop generation process 200 include a mainframe, a mini-computer, a personal computer system including notebook computers, a wireless, mobile computing device (including personal digital assistants, smart phones, and tablet computers). These computer systems are typically designed to provide computing power to one or more users, either locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the workshop generation environment 100 and workshop generation process 200 can be implemented using code stored in a tangible, non-transient computer readable medium and executed by one or more processors. In at least one embodiment, the workshop generation environment 100 and workshop generation process 200 can be implemented completely in hardware using, for example, logic circuits and other circuits including field programmable gate arrays.

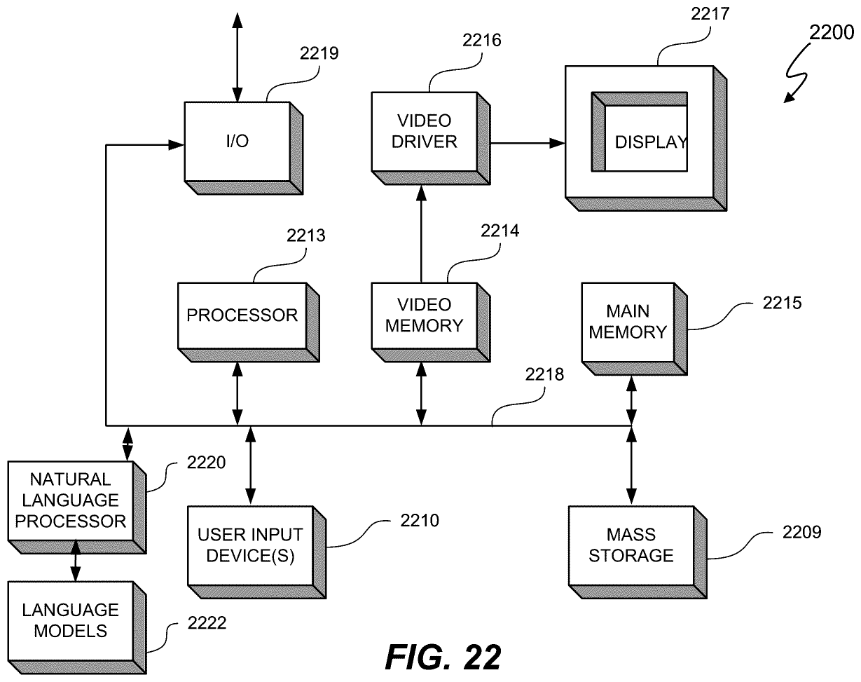

Embodiments of the workshop generation environment 100 and workshop generation process 200 can be implemented on a computer system such as a special-purpose, special-programmed computer 2200 illustrated in FIG. 22. Input user device(s) 2210, such as a keyboard and/or mouse, are coupled to a bi-directional system bus 2218. The input user device(s) 2210 are for introducing user input to the computer system and communicating that user input to processor 2213. The computer system of FIG. 22 generally also includes a non-transitory video memory 2214, non-transitory main memory 2215, and non-transitory mass storage 2209, all coupled to bi-directional system bus 2218 along with input user device(s) 2210 and processor 2213. The mass storage 2209 may include both fixed and removable media, such as a hard drive, one or more CDs or DVDs, solid state memory including flash memory, and other available mass storage technology. Bus 2218 may contain, for example, 32 of 64 address lines for addressing video memory 2214 or main memory 2215. The system bus 2218 also includes, for example, an n-bit data bus for transferring DATA between and among the components, such as CPU 2209, main memory 2215, video memory 2214 and mass storage 2209, where “n” is, for example, 32 or 64. Alternatively, multiplex data/address lines may be used instead of separate data and address lines.

I/O device(s) 2219 may provide connections to peripheral devices, such as a printer, and may also provide a direct connection to a remote server computer systems via a telephone link or to the Internet via an ISP. I/O device(s) 2219 may also include a network interface device to provide a direct connection to a remote server computer systems via a direct network link to the Internet via a POP (point of presence). Such connection may be made using, for example, wireless techniques, including digital cellular telephone connection, Cellular Digital Packet Data (CDPD) connection, digital satellite data connection or the like. Examples of I/O devices include modems, sound and video devices, and specialized communication devices such as the aforementioned network interface.

Computer programs and data are generally stored as code in a non-transient computer readable medium such as a flash memory, optical memory, magnetic memory, compact disks, digital versatile disks, and any other type of memory. The computer program is loaded from a memory, such as mass storage 2209, into main memory 2215 for execution. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 2213, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 2215 is comprised of dynamic random access memory (DRAM). Video memory 2214 is a dual-ported video random access memory. One port of the video memory 2214 is coupled to video amplifier 2216. The video amplifier 2216 is used to drive the display 2217. Video amplifier 2216 is well known in the art and may be implemented by any suitable means. This circuitry converts pixel DATA stored in video memory 2214 to a raster signal suitable for use by display 2217. Display 2217 is a type of monitor suitable for displaying graphic images.

The computer system described above is for purposes of example only. The workshop generation environment 100 and workshop generation process 200 may be implemented in any type of computer system or programming or processing environment. It is contemplated that the workshop generation environment 100 and workshop generation process 200 might be run on a stand-alone computer system, such as the one described above. The workshop generation environment 100 and workshop generation process 200 might also be run from a server computer systems system that can be accessed by a plurality of client computer systems interconnected over an intranet network. Finally, the workshop generation environment 100 and workshop generation process 200 may be run from a server computer system that is accessible to clients over the Internet.

Although embodiments have been described in detail, it should be understood that various changes, substitutions, and alterations can be made hereto without departing from the spirit and scope of the invention as defined by the appended claims.

What is claimed is:

1. A method comprising:
providing a user interface to integrate communication between a workshop planner client computer system and an artificial intelligence based workshop generation system (AI-based workshop generation system) to:
receive a workshop generation request from a user via the user interface of the workshop planner client computer system;
transmit the workshop generation request to the AI-based workshop generation system, wherein the AI-based workshop generation system includes an artificial intelligence system having a natural language processing engine that includes a language model and machine learning algorithms;
receiving, with the AI-based workshop generation system, the workshop generation request from the workshop planner client computer system, wherein the workshop generation request includes a natural language request data describing a life skill and a level of education for which the workshop is desired; and
processing the workshop generation request data by the AI-based workshop generation system comprises:
accessing a curriculum database including curriculum data for one or more life skills, wherein the curriculum data includes a plurality of life skill topics and corresponding topic details;
matching the received workshop generation request data to the curriculum data to identify a matching topic in the curriculum data;
identifying an objective of a workshop by using a research module, wherein the research module includes a plurality of research agents, and wherein each research agent from the plurality of research agents comprises a research prompt to develop methodologies for creating workshop content related to the selected topic corresponding to the workshop generation request;
creating a test2pass for the workshop by using a test2pass module, wherein the test2pass module includes a plurality of test2pass agents, and wherein each test2pass agent from the plurality of test2pass agents comprises a test2pass prompt to create test2pass; and
generating a workshop by using a workshop module, wherein the workshop module includes a plurality of workshop agent, and wherein each workshop agent from the plurality of workshop agents comprises a workshop prompt to generate and align the workshop with the workshop generation request data; and
providing data to display the workshop and the test2pass simultaneously to a user via the user interface of the workshop planner client computer system.

2. The method of claim 1 wherein accessing a curriculum database including curriculum data for one or more educational standards comprises:
requesting access to the curriculum database through the API endpoints of the curriculum database.

3. The method of claim 1 wherein the curriculum data is aligned to one or more educational standards including Common Core State Standards (CCSS), Next Generation Science Standards (NGSS), and College Board.

4. The method of claim 1 wherein
identifying the objective of the workshop by using the research module, the research module utilizes a plurality of research prompts, wherein the plurality of research prompts include research global assessments prompt, research assessment tools prompt, final assessment ideas summarization prompt, and research assessment questions generation prompt.

5. The method of claim 1 wherein:
creating test2pass by using the test2pass module, the test2pass module utilizes a plurality of test2pass prompts, wherein the plurality of test2pass prompts include rank Test2Passes prompt, Test2Pass designer system message, Test2Pass excitement QC system message, Test2Pass life skill alignment QC system message, Test2Pass no rubrics QC system message, Test2Pass objectivity QC system message, Test2Pass prompt, and Test2Pass QC user system message.

6. The method of claim 1 wherein generating the workshop by using the workshop module, the workshop module utilizes a plurality of workshop prompts, wherein the plurality of workshop prompts include workshop copywriter system message, workshop curriculum developer system message, workshop daily plans prompt, workshop evaluation specialist system message, and workshop school director system message.

7. The method of claim 1 wherein allowing the user to generate:
a plurality of workshops based on plurality of workshop generation request data on the workshop planner client computer system

8. The method of claim 1 wherein generating a plurality of test2passes by using test2pass module and ranking the generated plurality of test2pass based on the predefined criteria to be utilized in the workshop, wherein the predefined criteria includes life skill alignment, performance-based test2pass, clear, measurable, and objective criteria, availability of test2pass, and alignment with standard.

9. The method of claim 1 wherein displaying the life skill to the user via the user interface of the workshop planner client computer system comprises:
allowing the user to delete and edit in the life skill, via the user interface of the workshop planner client computer system, to generate a final workshop as per his preferences.

10. The method of claim 1 wherein modifying the plurality of research prompts, plurality of test2pass prompts and plurality of workshop prompts by the user via the user interface of the workshop planner client computer system.

11. The method of claim 1 wherein completion of the workshop is determined, when a learner scores greater than a predetermined threshold score in the test2pass of the workshop.

12. The method of claim 1 wherein receiving the workshop generation request from the workshop planner client computer system comprises:
providing a user interface to the user, on the workshop planner client computer system, to select:
a skill and at least one sub-skill included in the skill; and
grade level of an end-user who will be taking the generated workshop.

13. The method of claim 1 wherein generating the workshop includes details of the workshop, day plan of the workshop, conversation, comment and feedback for re-generation of the workshop.

14. A system comprising:
a user interface provided to integrate communication between a workshop planner client computer system and an artificial intelligence (AI)-based workshop generation system (AI-based workshop generation system), wherein the user interface is capable to
receive a workshop generation request from a user via the user interface of the workshop planner client computer system;
transmit the workshop generation request to the AI-based workshop generation system, wherein the AI-based workshop generation system includes an artificial intelligence system having a natural language processing engine that includes a language model and machine learning algorithms;
wherein the AI-based workshop generation system receives and processes the workshop generation request from the workshop planner client computer system, wherein the workshop generation request includes a natural language request data describing the life skill and level of education for which the workshop is desired, the AI-based workshop generation system comprises:
a curriculum database including curriculum data for accessing one or more educational standards, wherein the curriculum data includes a plurality of life skill topics and topic details to match the received workshop generation request data to the curriculum data to identify a matching topic in the curriculum data;
a research module for identifying an objective of a workshop, wherein the research module includes a plurality of research agents, and wherein each research agents from the plurality of research agents comprises a research prompt to develop methodologies for creating workshop content related to the selected topic corresponding to the workshop generation request;
a test2pass module for creating a test2pass, wherein the test2pass module includes a plurality of test2pass agents, and wherein each test2pass agent from the plurality of test2pass agents comprises a test2pass prompt to create test2pass;
a workshop module for generating a workshop, wherein the workshop includes a plurality of workshop agents, and wherein each workshop agent from the plurality of workshop agent comprises a workshop prompt to generate and align the workshop with the workshop generation request data; and
data to display to a user via the user interface of the workshop planner client computer system the workshop and the test2pass simultaneously.

15. The system of claim 14 wherein
the research module utilizes a plurality of research prompts to identify an objective of the workshop, wherein the plurality of research prompts include research global assessments prompt, research assessment tools prompt, final assessment ideas summarization prompt, and research assessment questions generation prompt.

16. The system of claim 14 wherein
the test2pass module utilizes a plurality of test2pass prompts to create a test2pass, wherein the plurality of test2pass prompts include rank Test2Passes prompt, Test2Pass designer system message, Test2Pass excitement QC system message, Test2Pass life skill alignment QC system message, Test2Pass no rubrics QC system message, Test2Pass objectivity QC system message, Test2Pass prompt, and Test2Pass QC user system message.

17. The system of claim 14 wherein
the workshop module utilizes a plurality of workshop prompts to generate a workshop, wherein the plurality of workshop prompts include workshop copywriter system message, workshop curriculum developer system message, workshop daily plans prompt, workshop evaluation specialist system message, and workshop school director system message.

18. The system of claim 14 wherein allowing the user to generate:
a plurality of workshops based on plurality of workshop generation request data on the workshop planner client computer system

19. The system of claim 14 wherein displaying the generated workshop to the user via the user interface of the workshop planner client computer system comprises:
allowing the user to delete, edit, or add one or more new questions in the generated workshop, via the user interface of the workshop planner client computer system, to generate a final workshop as per his preferences.

20. The system of claim 14 wherein modifying the plurality of research prompts, plurality of test2pass prompts and plurality of workshop prompts by the user via the user interface of the workshop planner client computer system.

21. The system of claim 14 wherein completion of the workshop is determined, when a learner scores greater than a predetermined threshold score in the highly ranked assessment of the corresponding workshop.

22. The system of claim 14 wherein the workshop generation request from the workshop planner client computer system comprises:
providing a user interface to the user, on the workshop planner client computer system, to select:
a skill and at least one sub-skill included in the skill; and
grade level of an end-user who will be taking the generated workshop.

23. The system of claim 14 wherein the workshop generation request includes details of the workshop, day plan of the workshop, conversation, comment and feedback for re-generation of the workshop.

24. The system of claim 14 further comprises:
a memory for storing the workshop generation requests, workshop generation request data, plurality of research prompts, plurality of test2pass prompts, plurality of workshop prompts, test2pass, generated workshop.
